(19) United States
(12) Patent Application Publication
(10) Pub. No.: US 2025/0181235 A1
(43) Pub. Date: Jun. 5, 2025

(54) ELECTRONIC DEVICE AND OPERATION METHOD THEREOF

(71) Applicant: SAMSUNG ELECTRONICS CO., LTD., Suwon-si (KR)

(72) Inventor: Jongkeun LEE, Suwon-si (KR)

(73) Assignee: SAMSUNG ELECTRONICS CO., LTD., Suwon-si (KR)

(21) Appl. No.: 19/051,680

(22) Filed: Feb. 12, 2025

Related U.S. Application Data
(63) Continuation of application No. PCT/KR2023/010515, filed on Jul. 20, 2023.

(30) Foreign Application Priority Data
Sep. 15, 2022 (KR) 10-2022-0116684
Nov. 21, 2022 (KR) 10-2022-0156686

(51) Int. Cl. G06F 3/0487; G06F 3/04815; G06F 3/0484; H04N 21/422

(52) U.S. Cl. CPC G06F 3/0487; G06F 3/04815; G06F 3/0484; H04N 21/42206

(57) ABSTRACT

An electronic apparatus includes a display; a communication interface; memory storing instructions; and one or more processors, wherein the instructions, when executed by the one or more processors, cause the electronic apparatus to receive a control signal from a control apparatus via the communication interface; based on content to be output via the display being a first type of content, output the content, via the display, in a first mode based on the control signal; and based on the content being a second type of content, output the content, via the display, in a second mode based on the control signal, wherein the control signal includes at least one of a first control signal based on a selection of a first directional key provided on the control apparatus, and a second control signal based on a selection of a second directional key on the control apparatus.

### CROSS-REFERENCE TO RELATED APPLICATIONS

This application is a by-pass continuation application of International Application No. PCT/KR2023/010515, filed on Jul. 20, 2023, which is based on and claims priority to Korean Patent Application No. 10-2022-0116684, filed on Sep. 15, 2022, and Korean Patent Application No. 10-2022-0156686, filed on Nov. 21, 2022, in the Korean Intellectual Property Office, the disclosures of which are incorporated by reference herein in their entireties.

### 1. FIELD

The disclosure relates to an electronic apparatus and an operating method thereof, and more particularly, to an electronic apparatus for controlling content to be output in various modes according to a control signal from a control apparatus, and to an operating method thereof.

### 2. DESCRIPTION OF RELATED ART

Users may control the operation of electronic apparatuses, such as televisions, by using control apparatuses such as remote controllers. When a user selects one of a plurality of keys included in a remote controller, the remote controller may generate a control signal corresponding to an input of the selected key and transmit the control signal to an electronic apparatus. The electronic apparatus may be controlled according to the control signal received from the remote controller.

As technology has developed, electronic apparatuses may output various forms of content in addition to broadcast content. Accordingly, various types of content may be controlled by using a remote controller.

### SUMMARY

According to an aspect of the disclosure, an electronic apparatus includes: a display; a communication interface; memory storing one or more instructions; and one or more processors operatively connected to the display, the communication interface and the memory, wherein the one or more instructions, when executed by the one or more processors, cause the electronic apparatus to: receive a control signal from a control apparatus via the communication interface, based on content to be output via the display being a first type of content, output the content, via the display, in a first mode based on the control signal, and based on the content being a second type of content, output the content, via the display, in a second mode based on the control signal, and the control signal includes at least one of a first control signal based on a selection of a first directional key of the control apparatus, and a second control signal based on a selection of a second directional key of the control apparatus that is different from the first directional key.

The first type of content includes metaverse content, and the second type of content includes viewing content.

The one or more instructions, when executed by the one or more processors, may cause the electronic apparatus to output, via the display, a guide user interface (UI), and the guide UI may include at least one of a first guide UI indicating a first operation to be performed based on the selection of the first directional key, and a second guide UI indicating a second operation to be performed based on the selection of the second directional key.

The one or more instructions, when executed by the one or more processors may cause the electronic apparatus to output, via the display, the guide UI at a preset time interval or at a time based on an event occurring, and the event may include at least one of a first event in which a type of content being output via the display is changed, and a second event in which a function controlled based on the control signal is changed.

The one or more instructions, when executed by the one or more processors, may cause the electronic apparatus to, based on the content being output via the display being the first type of content, control the content to be output via the display in the first mode by: controlling a movement direction of an avatar in the metaverse content based on one control signal from among the first control signal and the second control signal, and controlling a gaze direction of the avatar based on another control signal from among the first control signal and the second control signal.

The one or more instructions, when executed by the one or more processors, may cause the electronic apparatus to: receive, from the control apparatus via the communication interface, a sensing signal for a movement of the control apparatus, and control a gesture of the avatar based on the sensing signal.

The one or more instructions, when executed by the one or more processors, may cause the electronic apparatus to, based on the content being output being the second type of content, control the content to be output, via the display, in the second mode by: controlling, based on the first control signal, a movement direction of a focus for selecting an object included in the viewing content, and allowing, based on the second control signal, a function corresponding to the second control signal to be performed, the function being performable on a screen for the viewing content currently being output.

The one or more instructions, when executed by the one or more processors, may cause the electronic apparatus to: output, via the display, a second guide UI indicating an operation to be performed based on the selection of the second directional key; and based on the second control signal being received, allow the function corresponding to the second control signal to be performed without receiving an additional control signal, and
the function corresponding to the second control signal corresponds to the operation, and the operation is guided by the second guide UI.

The one or more instructions, when executed by the one or more processors, may cause the electronic apparatus to, based on the content to be output, via the display, being a third type of content including video call content, control the content to be output, via the display, in a third mode based on the control signal by: controlling, based on the first control signal, a movement direction of a focus for selecting one screen from among a plurality of screens included in the video call content, and adjusting, based on the second control signal, at least one of a size, a position, an angle of view, and a zoom function, of the selected screen.

According to an aspect of the disclosure, a control apparatus includes: an input interface; a communication interface; memory storing one or more instructions; and one or more processors operatively connected to the input interface, the communication interface, and the memory, wherein the one or more instructions, when executed by the one or more processors, cause the control apparatus to transmit, via the communication interface, a control signal to an electronic apparatus, the input interface may include a first directional key and a second directional key that is different from the first directional key, and the first directional key is provided on a front surface of the control apparatus, and the second directional key is provided on the front surface, a back surface, a rear surface, or a side surface of the control apparatus.

The first directional key and the second directional key may be positioned within a range on the control apparatus such that the first directional key and the second directional key are simultaneously operable by a user with one hand.

According to an aspect of the disclosure, an operating method of an electronic apparatus, the operating method includes: receiving a control signal from a control apparatus; based on content to be output, via a display, being a first type of content, outputting the content, via the display, in a first mode based on the control signal; and based on the content being output, via the display, being a second type of content, outputting the content, via the display, in a second mode based on the control signal, wherein the control signal includes at least one of a first control signal based on a selection of a first directional key of the control apparatus and a second control signal based on a selection of a second directional key of the control apparatus that is different from the first directional key.

The first type of content may include metaverse content, and the second type of content may include viewing content.

The operating method may further include outputting, via the display, a guide user interface (UI), and the guide UI may include at least one of a first guide UI indicating a first operation to be performed based on the selection of the first directional key, and a second guide UI indicating a second operation to be performed based on the selection of the second directional key.

The outputting the guide UI may include outputting, via the display, the guide UI at a preset interval or at a time based on an event occurring, and the event may include at least one of a first event in which a type of content being output, via the display, is changed, and a second event in which a function controlled based on the control signal is changed.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram illustrating how an electronic apparatus controls content to be output based on a control signal from a control apparatus, according to an embodiment.

FIG. 2 shows internal block diagrams of an electronic apparatus and a control apparatus according to an embodiment.

FIG. 3 is an internal block diagram of a processor of an electronic apparatus according to an embodiment.

FIG. 4 is a diagram illustrating how an electronic apparatus controls content to be output in a first mode based on a control signal from a control apparatus, according to an embodiment.

FIG. 5 is a diagram illustrating how an electronic apparatus controls content to be output in a first mode based on a control signal from a control apparatus, according to an embodiment.

FIG. 6 is a diagram illustrating how an electronic apparatus controls content to be output in a second mode based on a control signal from a control apparatus, according to an embodiment.

FIG. 7 is a diagram illustrating how an electronic apparatus controls content to be output in a second mode based on a control signal from a control apparatus, according to an embodiment.

FIG. 8 is a diagram illustrating how an electronic apparatus controls content to be output in a third mode based on a control signal from a control apparatus, according to an embodiment.

FIG. 9 shows a case where a control apparatus includes three or more directional keys, according to an embodiment.

FIG. 10 is an internal block diagram of an electronic apparatus according to an embodiment.

FIG. 11 is a flowchart illustrating an operating method of an electronic apparatus, according to an embodiment.

FIG. 12 is a diagram illustrating how an electronic apparatus controls content to be output in a first mode based on a control signal from a control apparatus, according to an embodiment.

FIG. 13 is a diagram illustrating how an electronic apparatus controls content to be output in a second mode based on a control signal from a control apparatus, according to an embodiment.

FIG. 14 is a diagram illustrating how an electronic apparatus controls content to be output in a third mode based on a control signal from a control apparatus, according to an embodiment.

### DETAILED DESCRIPTION

The embodiments described in the disclosure, and the configurations shown in the drawings, are only examples of embodiments, and various modifications may be made without departing from the scope and spirit of the disclosure.

A control apparatus according to an embodiment may include an input interface, a communication interface, a memory storing one or more instructions, and one or more processors configured to execute the one or more instructions stored in the memory.

In an embodiment, the one or more processors may be configured to execute the one or more instructions to transmit a control signal to an electronic apparatus via the communication interface.

In an embodiment, the input interface may include a first directional key and a second directional key different from the first directional key.

In an embodiment, the first directional key may be arranged on a front surface of the control apparatus, and the second directional key may be arranged on at least one of the front surface, a back surface, a rear surface, and a side of the control apparatus.

An operating method of an electronic apparatus according to an embodiment may include receiving a control signal from a control apparatus.

In an embodiment, the operating method of the electronic apparatus may include, when content being output is a first type of content, controlling the content to be output in a first mode based on the control signal.

In an embodiment, the operating method of the electronic apparatus may include, when the content being output is a second type of content, controlling the content to be output in a second mode based on the control signal.

In an embodiment, the control signal may include at least one of a first control signal based on selection of a first directional key provided on the control apparatus and a second control signal based on selection of a second directional key different from the first directional key.

A recording medium according to an embodiment may be a computer-readable recording medium having recorded thereon a program that may execute, by a computer, an operating method of an electronic apparatus, the operating method including receiving a control signal from a control apparatus.

In an embodiment, the recording medium may be a computer-readable recording medium having recorded thereon a program that may execute, by a computer, an operating method of an electronic apparatus, the operating method including, when content is a first type of content, controlling the content to be output in a first mode based on the control signal.

In an embodiment, the recording medium may be a computer-readable recording medium having recorded thereon a program that may execute, by a computer, an operating method of an electronic apparatus, the operating method including, when content being output is a second type of content, controlling the content to be output in a second mode based on the control signal.

In an embodiment, the recording medium may be a computer-readable recording medium having recorded thereon a program that may execute, by a computer, an operating method of an electronic apparatus, wherein the control signal includes at least one of a first control signal based on selection of a first directional key provided on the control apparatus and a second control signal based on selection of a second directional key different from the first directional key.

Throughout the present disclosure, the expression “at least one of a, b and c” indicates only “a”, only “b”, only “c”, both “a and b”, both “a and c”, both “b and c”, and all of “a, b, and c”.

Hereinafter, embodiments of the present disclosure will be described in detail with reference to the accompanying drawings such that one of ordinary skill in the art may implement the present disclosure. The present disclosure may, however, be embodied in many different forms and should not be construed as limited to the embodiments of the present disclosure set forth herein.

The terms used in the present disclosure are those terms currently used in the art in consideration of functions in regard to the disclosure, but the terms may have many different meanings according to the intention of those of ordinary skill in the art, precedents, or new technologies in the art. Thus, the terms used in the present disclosure should be understood not as simple names but based on the meaning of the terms and the overall description of the present disclosure.

In addition, the terms used in the present disclosure are for the purpose of describing exemplary embodiments and are not intended to limit the present disclosure.

Throughout the disclosure, when a portion is “connected” to another portion, the portion may not only be “directly connected” to the other portion, but the portion may also be “electrically connected” to the other portion with another element therebetween.

As used herein, the terms “the” and similar referents may refer to both the singular and plural forms. Also, the steps specified herein may be performed in any order, unless the order of steps in describing a method according to the present disclosure is explicitly specified. The present disclosure is not limited to the order of the steps specified herein.

The phrases “in some embodiments” or “in an embodiment” used in various locations throughout the disclosure do not necessarily all refer to the same embodiment.

Some embodiments of the present disclosure may be represented by functional block components and various processing steps. Some or all of these functional blocks may be implemented with any number of hardware and/or software components that perform various functions. For example, the functional blocks used in the present disclosure may be implemented by one or more microprocessors or by circuit components for a certain function. Also, for example, the functional blocks used in the present disclosure may be implemented in various programming or scripting languages. The functional blocks may be implemented as algorithms running on one or more processors. In addition, the present disclosure may employ the prior art for electronic environment setting, signal processing, and/or data processing. The terms “mechanism”, “element”, “means”, and “component” may be widely used and are not limited to mechanical and physical components.

Connection lines or connection members between components shown in the drawings are only illustrative of functional connections and/or physical or circuit connections. In an actual apparatus, connections between components may be represented by various alternative or additional functional, physical, or circuit connections.

In addition, the terms “ . . . or/er”, “ . . . module”, or the like as used herein refer to units that perform at least one function or operation, and the units may be implemented as hardware or software or as a combination of hardware and software.

Moreover, the term “user” as used herein may refer to a person who uses an electronic apparatus, and may include a consumer, an evaluator, a viewer, a manager, and an installation engineer.

The present disclosure will now be described more fully with reference to the accompanying drawings.

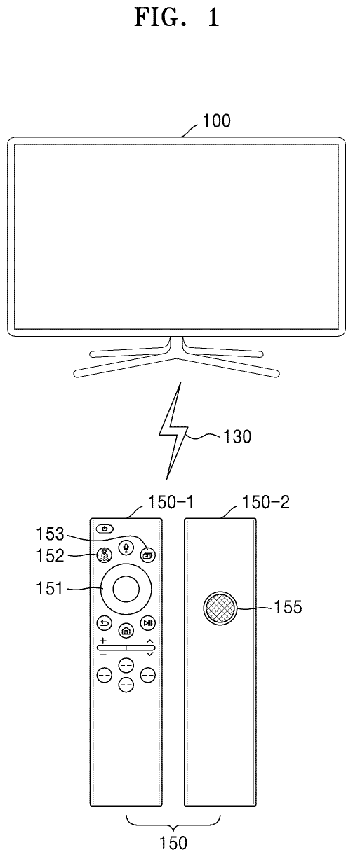

FIG. 1 is a diagram illustrating how an electronic apparatus 100 controls content to be output based on a control signal from a control apparatus 150, according to an embodiment.

Referring to FIG. 1, the electronic apparatus 100 may include an electronic apparatus capable of outputting images. According to an embodiment, the electronic apparatus 100 may be implemented as any form of electronic apparatus including a display. The electronic apparatus 100 may be fixed or mobile and may include a digital television (TV) capable of receiving digital broadcasting, but is not limited thereto.

In an embodiment, the electronic apparatus 100 may include at least one of a desktop computer, a smartphone, a tablet personal computer (PC), a mobile phone, a video phone, an e-book reader, a laptop PC, a netbook computer, a digital camera, a personal digital assistant (PDA), a portable multimedia player (PMP), a camcorder, a navigation device, a wearable device, a smartwatch, a home network system, a security system, and a medical device.

The electronic apparatus 100 may be implemented as a flat display apparatus, a curved display apparatus having a screen with curvature, or a flexible display apparatus of which curvature is adjustable. For example, output resolution of the electronic apparatus 100 may have various resolutions such as high definition (HD), full HD, ultra HD, or a resolution clearer than ultra HD.

The electronic apparatus 100 may output various types of content provided by content providers. The content may include still images, a video such as moving images, audio, subtitles, other additional information, etc. A content provider may refer to a terrestrial broadcaster, a cable broadcaster, satellite broadcaster, an Internet protocol television (IPTV) service provider, or an over-the-top (OTT) service provider that provides various types of content to consumers.

In an embodiment, the electronic apparatus 100 may receive, via an external device, various types of content generated by the content provider and output the content. For example, the external device may be implemented as any type of source apparatus such as a PC, a set-top box, a Blu-ray disc player, a mobile phone, a game console, a home theater, an audio player, or a universal serial bus (USB). The external device may be connected to the electronic apparatus 100 via a wired communication network, such as high-definition multimedia interface (HDMI) or a wireless communication network, and provide various types of content to the electronic apparatus 100. The electronic apparatus 100 may receive, via a set-top box, video-on-demand (VOD) content provided by the IPTV service provider or the OTT service provider and output the VOD content. A VOD service provides videos desired by users at desired times via a communication network connection and may refer to various types of content provided by the OTT service provider or the IPTV service provider. The IPTV service provider or the OTT service provider may provide VOD content and real-time broadcast programs.

In an embodiment, the electronic apparatus 100 may include a smart TV. The smart TV may refer to a digital TV having an operating system (OS) and an Internet access function. The smart TV may also be referred to as an Internet TV, a connected TV, or a hybrid TV.

In an embodiment, the electronic apparatus 100 may stream and output various types of VOD content generated by the OTT service provider, such as YouTube or Netflix, in addition to the real-time broadcast programs, by using the OS installed therein.

Hereinafter, content viewable by users, such as broadcast programs or VOD content, is referred to as viewing content.

In an embodiment, the electronic apparatus 100 may connect to the Internet and provide a web surfing service, a social network service, etc. Also, the electronic apparatus 100 may function as a communication center where news, weather, email, etc. may be checked in real time.

In an embodiment, the electronic apparatus 100 may execute various types of applications. Various types of applications may be installed on the electronic apparatus 100 by default. The electronic apparatus 100 may, under control by a user, access the Internet, search for an application requested by the user, and install the application. The electronic apparatus 100 may provide various services by executing the application. For example, the electronic apparatus 100 may execute an application that provides a video call service and provide the video call service concerning another user located remotely.

In an embodiment, the electronic apparatus 100 may be controlled by the control apparatus 150. In an embodiment, the control apparatus 150 may be a device used to control the electronic apparatus 100, such as a remote controller. The user may control various functions of the electronic apparatus 100 by using the control apparatus 150.

In an embodiment, the control apparatus 150 may have an input interface. The input interface may receive a user input for controlling the electronic apparatus 100. The input interface included in the control apparatus 150 may include a plurality of keys. The keys may have various forms such as a physical button that receives a push operation from a user, a jog & shuttle, or a touch button displayed on a touchpad that detects touch. The user may control various functions of the electronic apparatus 100 by using the plurality of keys provided in the control apparatus 150.

The plurality of keys included in the control apparatus 150 may be used to control various functions of the electronic apparatus 100. The user may use the control apparatus 150 to perform various functions of the electronic apparatus 100, such as turning the power on/off, changing channels, adjusting the volume, selecting one of various broadcasts such as terrestrial broadcasting, cable broadcasting, satellite broadcasting, and Internet broadcasting, selecting an object such as an item or content on a screen, or configuring environment settings.

For remote controllers in the related art, various types of keys used to control the electronic apparatus 100, such as number keys, channel control keys, volume control keys, direction selection keys, and menu selection keys, are all exposed on the front. For example, most remote controllers of the related art include keys directly matching TV functions. Because a remote controller includes many different types of buttons, it is difficult for the user to find a button to perform a function, and instead of looking at content displayed on an electronic apparatus, the user has to select the button to perform the function while looking at the remote controller.

Accordingly, remote controllers that have a minimized number of rarely used buttons and include only buttons for functions frequently used by users have recently been developed and used. The user may operate a button provided on the remote controller while looking at a screen of the electronic apparatus 100 without having to look at the remote controller to find a key corresponding to a desired function one by one.

As TVs have evolved into smart TVs, TV functions has become more complex and many new features have emerged. Users are no longer limited to using remote controllers to perform operations, such as turning the power on/off, adjusting the volume, and changing channels, but are also used to execute various operations or services such as application search, web surfing, social networking service (SNS), VOD, video calls, and games. As TVs may now perform various functions, it is difficult to match all the functions performed by a TV with a small number of keys on a remote controller and use the functions. Accordingly, in order to control various functions of the TV with the small number of buttons on the remote controller, the user has to select the buttons on the remote controller in several steps or depths.

FIG. 1 shows that the electronic apparatus 100 receives a control signal from the control apparatus 150 via a communication network 130, according to an embodiment. In an embodiment, the control apparatus 150 is an example of a remote controller including only a small number of buttons. A front surface 150-1 and a back surface 150-2 of the control apparatus 150 are shown in FIG. 1.

In an embodiment, the control apparatus 150 may include a plurality of keys. In an embodiment, the control apparatus may include a plurality of directional keys 151 and 155.

For example, as shown in FIG. 1, the control apparatus 150 may include the first directional key 151 on the front surface 150-1 and the second directional key 155 on the back surface 150-2. However, this is only an embodiment, and the control apparatus 150 may include the first directional key 151 on the front surface 150-1 and the second directional key 155 on the front surface, a rear surface, or a side, rather than the back surface 150-2 of the control apparatus 150. Alternatively, the control apparatus 150 may include both the first directional key 151 and the second directional key 155 on the front surface 150-1. Alternatively, the control apparatus 150 may include both the first directional key 151 and the second directional key 155 on the front surface 150-1 and another third directional key on the back surface 150-2.

Users of TVs may want to view content output from the electronic apparatus 100 in a comfortable position. For example, a user may tend to watch TV in a “lean back” position with his upper body tilted backward. Because the remote controller is also a user interface (UI) used while the user is watching TV in a comfortable position, the remote controller may be developed into a form that may be operated with one hand.

In an embodiment, the plurality of directional keys 151 and 155 provided on the control apparatus 150 may be positioned in a position operable by the user with one hand. For example, when the first directional key 151 is arranged on the front surface 150-1 of the control apparatus 150 and the second directional key 155 is arranged on the back surface 150-2 of the control apparatus 150, the first directional key 151 may be arranged in a position operable by a thumb of the user, and the second directional key 155 may simultaneously be arranged in a position operable by an index or middle finger of the user.

In an embodiment, when one of the directional keys 151 and 155 is selected, the control apparatus 150 may generate a control signal corresponding to the selected key among the directional keys 151 and 155. In an embodiment, the control signal may include at least one of a control signal based on selection of the first directional key 151 provided on the control apparatus 150 and a control signal based on selection of the second directional key 155.

The control signal based on the selection of the first directional key 151 provided on the control apparatus 150 is referred to as a first control signal, and the control signal based on selection of the second directional key 155 different from the first directional key is referred to as a second control signal. The first control signal may include a control signal including key code instructions respectively corresponding to four directions of the first directional key 151. Also, the second control signal may include a control signal including key code instructions respectively corresponding to four directions of the second directional key 155.

In an embodiment, when one of the directional keys 151 and 155 is selected, the control apparatus 150 may transmit, to the electronic apparatus 100, the control signal corresponding to the selected key among the directional keys 151 and 155.

In an embodiment, the electronic apparatus 100 may receive the control signal from the control apparatus 150 and perform an operation corresponding to the control signal.

In an embodiment, according to the type of content currently being output, the electronic apparatus 100 may operate differently in response to the control signal. For example, in an embodiment, when the control signal is received from the control apparatus 150, according to the type of content currently being output, the electronic apparatus 100 may control content to be output in different modes in response to the same control signal.

The type of content refers to the type or kind of content and, according to whether the content is metaverse content, viewing content, or video call content, may be classified into different types such as a first type, a second type, and a third type. However, the present disclosure is not limited thereto, and the type of content may have various forms such as content for Internet browser access, content for web surfing, and content for providing SNS services such as real-time chat rooms.

In an embodiment, the electronic apparatus 100 may output a guide UI. The guide UI may include an interface that, according to the type of content currently being output, guides operations or functions performed when the plurality of directional keys 151 and 155 are selected.

When the operations performed by selecting the directional keys 151 and 155 vary according to the type of content, the user may become confused about which key to select to control the content. Accordingly, in an embodiment, the electronic apparatus 100 may generate a guide UI for the type of content being output and output the guide UI together with the content.

In an embodiment, the guide UI may include at least one of a first guide UI indicating an operation to be performed based on selection of the first directional key 151 and a second guide UI indicating an operation to be performed based on selection of the second directional key 155.

In an embodiment, the electronic apparatus 100 may output the guide UI at preset time intervals or each time an event occurs. In an embodiment, the event may include at least one of an event in which the type of content being output by the electronic apparatus 100 is changed, and an event in which a function controlled based on the control signal is changed.

The user may identify functions to be performed when the directional keys 151 and 155 are selected by using the guide UI displayed on the screen of the electronic apparatus 100, and control content by operating the directional keys 151 and 155 accordingly.

In an embodiment, when the content currently being output is a first type of content, the electronic apparatus 100 may control the content to be output in a first mode based on the control signal.

In an embodiment, the first type of content may include metaverse content. Metaverse may refer to a three-dimensional space platform where users may engage in social, economic, educational, cultural, and scientific and technological activities similar to those in real life by using avatars. The electronic apparatus 100 may output metaverse content by executing an application that provides metaverse content. The metaverse content may include content representing a virtual space provided by a metaverse platform.

Avatars controllable by users are featured in the metaverse content. A user may control his avatar so that the avatar interacts with other avatars, explores the surroundings, or performs operations appropriate to different situations. In order to control the operations of the avatar, the movement direction and the gaze direction of the avatar may be controlled, respectively.

Because a remote controller may include only one directional key, the user may be unable to control his avatar in the metaverse content via the electronic apparatus 100 by using a remote controller of the related art.

As in the embodiment, when the control apparatus 150 includes the first directional key 151 and the second directional key 155, the user may control the movement direction and the gaze of the avatar by using the first directional key 151 and the second directional key 155 provided on the control apparatus 150, respectively.

In an embodiment, the electronic apparatus 100 may control output of the metaverse content in the first mode based on at least one of the first control signal and the second control signal.

For example, in an embodiment, the electronic apparatus 100 may control the movement direction of the avatar in the metaverse content based on the first control signal according to input of the first directional key 151. Also, the electronic apparatus 100 may control the gaze direction of the avatar in the metaverse content based on the second control signal according to input of the second directional key 155.

In an embodiment, the electronic apparatus 100 may output a guide UI for the metaverse content while the metaverse content is output. For example, when the first directional key 151 is selected, the electronic apparatus 100 may output the first guide UI indicating that the movement direction of the avatar is controlled, and when the second directional key 155 is selected, the electronic apparatus 100 may output the second guide UI indicating that the gaze direction of the avatar is controlled.

In an embodiment, when the content currently being output is a second type of content, the electronic apparatus 100 may control the content to be output in a second mode based on the control signal.

In an embodiment, the second type of content may include viewing content. The viewing content may refer to content including videos or motion pictures that may be viewed, such as movies or soap operas. For example, the viewing content may include broadcast programs, VOD content via OTT services, or content such as videos, photos, or pictures obtained via an external device such as a USB or a PC.

In an embodiment, the viewing content may include a default screen that is displayed by default when the electronic apparatus 100 is turned on. The default screen may also be referred to as a home screen. The default screen may include a list of various VODs or executable applications.

In an embodiment, the viewing content may include various objects. In the present disclosure, an object may refer to an item selectable by a user using the control apparatus 150. In an embodiment, various pieces of VOD content or applications included in the default screen may each be an object.

In an embodiment, the viewing content may include preview content. The preview content introduces content such as movies or soap operas before the content is played, and may include at least one of information about the plot, actors, director, year of production of the content, and when the content is a series, the season and episode of the content, and a trailer for the content, such as a video. In an embodiment, the preview content may include various selectable objects such as selecting to play, adding the content to a watchlist, and selecting a liking rating for the content.

In an embodiment, while viewing the viewing content, the user may control the viewing content in various forms by using two or more directional keys provided on the control apparatus 150.

In an embodiment, the electronic apparatus 100 may control output of the viewing content in the second mode based on at least one of the first control signal and the second control signal.

For example, in an embodiment, the electronic apparatus 100 may control, based on the first control signal, a movement direction of a focus for selecting an object included in the viewing content. In an embodiment, the electronic apparatus 100 may select a new object by moving a cursor or a focus in a direction according to the first control signal.

Also, in an embodiment, the electronic apparatus 100 may allow, based on the second control signal, a function corresponding to the second control signal to be performed, wherein the function may be performed on a screen for the viewing content currently being output. The function that may be performed on the screen for the viewing content currently being output may vary according to a screen for content being output.

In an embodiment, because the second directional key 155 is provided on the control apparatus 150, the control apparatus 150 may replace a function of another button previously included in the remote controller with a function of the second directional key 155.

For example, in FIG. 1, a multi-key 152 positioned on the left side above the first directional key 151 is a button for providing various functions. The user may call up a setup function of the electronic apparatus 100 by selecting the multi-key 152. Also, each time the user presses the multi-key 152, the electronic apparatus 100 may output a color button window and a virtual number pad window. When the color button window is output onto the electronic apparatus 100, the user may select a color button by using the first directional key 151, and the electronic apparatus 100 may execute a function corresponding to a selected color. The function corresponding to the selected color may refer to an additional function for each function, which is provided differently according to the current content. Also, when the virtual number pad window is output onto the electronic apparatus 100, the user may change channels, enter a personal identification number (PIN), enter a zip code, etc. by selecting and inputting desired numbers by using the first directional key 151 in the virtual number pad window.

Also, in FIG. 1, a multi-view button 153 positioned on the right side above the first directional key 151 may be used to view the electronic apparatus 100 in multi-view. When the multi-view button 153 is selected, the electronic apparatus 100 may receive selection of content to be output in multi-view, and output a multi-view screen including two or more screens as partial screens.

In an embodiment, the second directional key 155 may provide at least one of the functions of the multi-key 152 and the functions of the multi-view button 153. In this case, the control apparatus 150 according to an embodiment may not include at least one of the multi-key 152 and the multi-view button 153.

In an embodiment, based on the second control signal according to the second directional key 155, the electronic apparatus 100 may perform the aforementioned operation when the multi-key 152 or the multi-view button 153 is selected. For example, while the second type of content is output, when a right direction of the second directional key 155 provided on the control apparatus 150 is selected, the electronic apparatus 100 may immediately output a screen indicating a setting function.

When the left direction of the second directional key 155 provided on the control apparatus 150 is selected, the electronic apparatus 100 may output the virtual number pad window on the screen.

When an up button of the second directional key 155 provided on the control apparatus 150 is selected, the electronic apparatus 100 may output a multi-view screen.

As described above, according to an embodiment, when the second control signal based on the selection of the second directional key 155 is received while the viewing content is output, the electronic apparatus 100 may allow various functions to be immediately executed at once. In this case, an operation that has been performed by operating the multi-key 152 several times, for example, performed by inputting keys over several steps or several depths, may be performed immediately by selecting the second directional key 155 only once, thereby providing user convenience.

In an embodiment, the electronic apparatus 100 may guide the user in performing an operation based on selection of a directional key by outputting the viewing content and outputting a guide UI for the viewing content. In an embodiment, the electronic apparatus 100 may output a second guide UI indicating which operation is to be performed when the second directional key 155 is selected. The second guide UI may vary according to the viewing content currently being output.

For example, the electronic apparatus 100 may output the second guide UI in a state in which a preview screen is output. In this case, the second guide UI being output may indicate that, when the second directional key 155 is selected, an operation, such as content playback, fast-forward, fast-rewind, or pause, may be performed according to each of the four directions included in the second directional key 155.

For example, when the electronic apparatus 100 outputs a default screen, the electronic apparatus 100 may output the second guide UI of which color matches a direction of the second directional key 155. The user may cause an operation corresponding to blue to be performed by selecting a direction, for example, a right button, matching a color, for example, blue, of the second directional key 155.

In an embodiment, when the content currently being output is a third type of content, the electronic apparatus 100 may control the content to be output in a third mode based on the control signal.

In an embodiment, the third type of content may include video call content.

In an embodiment, the content currently being output is the third type of content, the electronic apparatus 100 may control, based on one control signal among the first control signal and the second control signal, a movement direction of a focus for selecting one of a plurality of screens included in the video call content.

In an embodiment, the electronic apparatus 100 may control at least one of the size, position, angle of view, and zoom function of the selected screen based on the other control signal among the first control signal and the second control signal.

In an embodiment, the electronic apparatus 100 may output a guide UI for the video call content while the video call content is output. The guide UI for video call content may guide the user to operations corresponding to the four directions of the second directional key 155, for example, zooming in or zooming out of the screen, adjusting the position of the screen, and moving the angle of view.

As described above, according to an embodiment, even when control signals are received from the same control apparatus 150, the electronic apparatus 100 may control content to be output in different modes according to the type of content currently being output.

Also, according to an embodiment, the electronic apparatus 100 may receive control signals corresponding to the directional keys 151 and 155 from the control apparatus 150 including two or more directional keys 151 and 155, respectively, and may control the content in various manners accordingly.

In addition, according to an embodiment, the electronic apparatus 100 may output a guide UI indicating operations to be performed when the directional keys 151 and 155 are selected.

While looking at the guide UI, the user may conveniently control various types of content in different modes by operating the plurality of directional keys 151 and 155 included in one control apparatus 150.

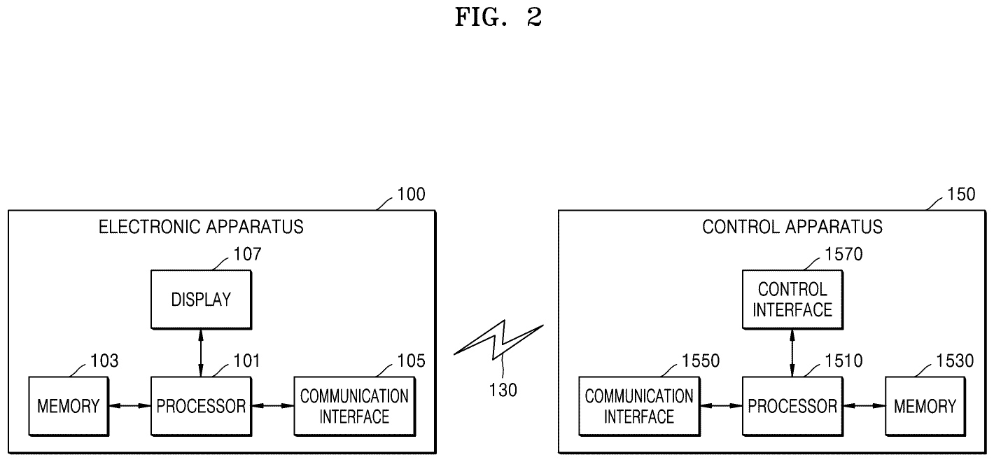

FIG. 2 shows internal block diagrams of the electronic apparatus 100 and the control apparatus 150 according to an embodiment.

Referring to FIG. 2, the electronic apparatus 100 and the control apparatus 150 may be connected to each other by using the communication network 130.

Referring to FIG. 2, the electronic apparatus 100 according to an embodiment may include a display 107, a communication interface 105, a memory 103 storing one or more instructions, and at least one processor 101 configured to execute the one or more instructions stored in the memory 103.

The memory 103 according to an embodiment may store at least one instruction. The memory 103 may store at least one program executable by the processor 101. Also, the memory 103 may store data input to the electronic apparatus 100 or output from the electronic apparatus 100.

The memory 103 may include at least one type of storage medium from among flash memory, hard disk, multimedia card micro memory, card type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, magnetic disk, or an optical disk.

In an embodiment, the memory 103 may store one or more instructions for identifying the type of content output by the display 107.

In an embodiment, the memory 103 may store one or more instructions for identifying a mode corresponding to the type of content currently being output.

In an embodiment, the memory 103 may store one or more instructions for identifying that, when the content currently being output is a first type of content, a content output mode corresponding to the first type of content is a first mode.

In an embodiment, the memory 103 may store one or more instructions for identifying that, when the content currently being output is a second type of content, a content output mode corresponding to the second type of content is a second mode.

In an embodiment, the memory 103 may store one or more instructions for identifying that, when the content currently being output is a third type of content, a content output mode corresponding to the third type of content is a third mode.

In an embodiment, the memory 103 may store one or more instructions for controlling content to be output according to an output mode.

In an embodiment, the memory 103 may store one or more instructions for controlling, when the output mode is the first mode, content to be output in the first mode.

In an embodiment, the one or more instructions for controlling the content to be output in the first mode may include an instruction for controlling a movement direction of an avatar in metaverse content based on one control signal among a first control signal and a second control signal.

In an embodiment, the one or more instructions for controlling the content to be output in the first mode may include one or more instructions for controlling a gaze direction of the avatar based on the other control signal among the first control signal and the second control signal.

In an embodiment, the memory 103 may store one or more instructions for controlling, when a sensing signal for movement of the control apparatus is received from the control apparatus 150, a gesture of the avatar based on the sensing signal.

In an embodiment, the memory 103 may store one or more instructions for controlling, when the output mode is the second mode, content to be output in the second mode.

In an embodiment, the one or more instructions for controlling the content to be output in the second mode may include one or more instructions for controlling, based on one of the first control signal and the second control signal, a movement direction of focus for selecting an object included in viewing content.

In an embodiment, the one or more instructions for controlling the content to be output in the second mode may include one or more instructions for causing a corresponding function to be performed based on one of the first control signal and the second control signal.

In an embodiment, the memory 103 may store one or more instructions for controlling, when the output mode is the third mode, content to be output in the third mode.

In an embodiment, the one or more instructions for controlling the content to be output in the third mode may include one or more instructions for controlling, based on one control signal among the first control signal and the second control signal, a movement direction of a focus for selecting one of a plurality of screens included in video call content.

In an embodiment, the one or more instructions for controlling the content to be output in the third mode may include one or more instructions for adjusting, based on the other control signal among the first control signal and the second control signal, at least one of the size, position, and angle of view of the selected screen.

In an embodiment, the memory 103 may store one or more instructions for outputting, according to the type of content, at least one of a first guide UI indicating an operation to be performed based on selection of a first directional key and a second guide UI indicating an operation to be performed based on selection of a second directional key.

In an embodiment, the memory 103 may store one or more instructions for outputting a guide UI.

In an embodiment, the memory 103 may store one or more instructions regarding a time point at which the guide UI is output.

The communication interface 105 according to an embodiment may communicate with at least one external electronic apparatus via a wired or wireless communication network.

The communication interface 105 may connect the electronic apparatus 100 to the control apparatus 150, or other peripheral devices, external devices, servers, mobile terminals, etc. under control by the processor 101.

The communication interface 105 may include at least one communication module capable of performing wireless communication. The communication interface 105 may include at least one of a wireless local area network (LAN) module, a Bluetooth module, and wired Ethernet according to the performance and structure of the electronic apparatus 100.

The communication interface 105 may include at least one short-range communication module configured to perform communication based on a communication standard such as Bluetooth, wireless fidelity (Wi-Fi), Bluetooth low energy (BLE), near-field communication (NFC)/radio frequency identification (RFID), Wi-Fi direct, ultra-wideband (UWB), or ZigBee.

Also, the communication interface 105 may further include a long-range communication module configured to communicate with a server for supporting long-range communication based on a long-range communication standard. In detail, the communication interface 105 may include a long-range communication module configured to perform communication via a network for Internet communication. For example, the communication interface 105 may include a long-range communication module configured to perform communication via a communication network based on a communication standard such as 3rd-generation (3G), 4th-generation (4G), and/or 5th-generation (5G).

In an embodiment, the communication interface 105 may communicate with the control apparatus 150 by using infrared (IR) communication, radio frequency (RF) communication, Wi-Fi communication, or BLE communication. The communication interface 105 may receive a control signal from the control apparatus 150 via communication with the control apparatus 150.

The processor 101 according to an embodiment controls all operations of the electronic apparatus 100. The processor 101 may execute the one or more instructions stored in the memory 103 to control the electronic apparatus 100 to function. In an embodiment, the electronic apparatus 100 may include one or a plurality of processors 101.

In an embodiment, the one or more processors 101 may execute the one or more instructions to receive a control signal from the control apparatus 150 via the communication interface 105.

In an embodiment, the one or more processors 101 may execute the one or more instructions to, when content output to the display 107 is a first type of content, control the content to be output in the first mode based on the control signal.

In an embodiment, the one or more processors 101 may execute the one or more instructions to, when the content output to the display 107 is a second type of content, control the content to be output in the second mode based on the control signal.

In an embodiment, the first type of content may include metaverse content, and the second type of content may include viewing content.

In an embodiment, the one or more processors 101 may execute the one or more instructions to output a guide UI via the display 107.

In an embodiment, the guide UI may include at least one of a first guide UI indicating an operation to be performed based on selection of the first directional key and a second guide UI indicating an operation to be performed based on selection of the second directional key.

In an embodiment, the one or more processors 101 may output the guide UI at preset time intervals or each time an event occurs. For example, the processors 101 may output a new guide UI for the type of content each time an event in which the type of content changes occurs. Also, the processors 101 may output a new guide UI that guides a new function each time an event in which a function controlled based on the control signal changes occurs.

In an embodiment, the one or more processors 101 may execute the one or more instructions to, when the content being output is a first type of content, for example, metaverse content, control a movement direction of an avatar in the metaverse content based on one control signal among the first control signal and the second control signal from the control apparatus 150. In an embodiment, the one or more processors 101 may control a gaze direction of the avatar based on the other control signal among the first control signal and the second control signal.

In an embodiment, the one or more processors 101 may execute the one or more instructions to receive, from the control apparatus 150 via the communication interface 105, a sensing signal for movement of the control apparatus 150. In an embodiment, the one or more processors 101 may control a gesture of the avatar based on the sensing signal.

In an embodiment, the one or more processors 101 may execute the one or more instructions to, when the content being output is a second type of content, for example, viewing content, control, based on the first control signal, a movement direction of a cursor or a focus for selecting an object included in the viewing content. In an embodiment, the one or more processors 101 may allow, based on the second control signal, a function corresponding to the second control signal to be performed, wherein the function may be performed on a screen for the viewing content currently being output. The function corresponding to the second control signal may be provided differently according to the screen and according to an executable function. For example, the function corresponding to the second control signal may vary according to the material of the content currently being output on the screen.

In an embodiment, the one or more processors 101 may execute the one or more instructions to output, via the display 107, a second guide UI indicating an operation to be performed based on the selection of the second directional key and, when the second control signal is received, allow a function corresponding to the second control signal to be immediately performed without receiving an additional control signal. In this case, the function corresponding to the second control signal may be an operation guided by the second guide UI.

In an embodiment, the one or more processors 101 may execute the one or more instructions to, when the content output to the display 107 is a third type of content, control the content to be output in the third mode based on the control signal. In an embodiment, the third type of content may include video call content. In an embodiment, the one or more processors 101 may execute the one or more instructions to control, based on one control signal among the first control signal and the second control signal, a movement direction of a focus for selecting one of a plurality of screens included in the video call content. In an embodiment, the one or more processors 101 may adjust at least one of the size, position, angle of view, and zoom function of the selected screen based on the other control signal among the first control signal and the second control signal.

The control apparatus 150 according to an embodiment may include a processor 1510, a memory 1530, a communication interface 1550, and an input interface 1570.

In an embodiment, the control apparatus 150 may be implemented as various types of devices used to control the electronic apparatus 100. The control apparatus 150 may be implemented as a terminal capable of receiving various forms of user input, for example, a touch, a press, a touch gesture, a speech, or a motion. For example, the control apparatus 150 may include a portable computer such as a laptop computer, a netbook, or a tablet PC, a portable terminal such as a smartphone or a PDA, a remote controller, a keyboard, a mouse, a joy pad, or a terminal in an integrated form of two or more of these devices, but is not limited thereto.

The memory 1530 according to an embodiment may include at least one instruction. The memory 1530 may store at least one program executable by the processor 1510. The memory 1530 may store pre-defined operation rules or programs. Also, the memory 1530 may store data input to the control apparatus 150 or output from the control apparatus 150.

In an embodiment, the memory 1530 may store a key code instruction. The key code instruction may include a defined key scan code value matching data and commands input from the input interface 1570. The memory 1530 may include a key code instruction corresponding to each of a plurality of keys included in the input interface 1570.

The memory 1503 may include at least one type of storage medium from among flash memory, hard disk, multimedia card micro memory, card type memory (e.g., SD or XD memory), RAM, SRAM, ROM, EEPROM, PROM, magnetic memory, magnetic disk, or an optical disk.

The input interface 1570 according to an embodiment may receive a user input for controlling the control apparatus 150. The input interface 1570 may be implemented in various forms. For example, the input interface 1570 may include a keypad. The keypad may include a button or a touchpad. The touchpad may be implemented in various forms such as a touch capacitance type, a pressure-resistive layer type, an IR sensor type, a surface ultrasonic conductive type, an integral tension measurement type, and a piezoelectric effect type. The input interface 1570 may include a keyboard, a dome switch, a jog wheel, a jog switch, or the like. The input interface 1570 may further include a microphone capable of receiving speech from a user.

In an embodiment, the input interface 1570 may include a plurality of directional keys. In an embodiment, the input interface 1570 may include the first directional key 151 and the second directional key 155. In an embodiment, the first directional key 151 may be arranged on the front surface 150-1 of the control apparatus 150, and the second directional key 155 may be arranged on at least one of the front surface, the back surface 150-2, a rear surface, and a side of the control apparatus 150.

In an embodiment, the first directional key 151 and the second directional key 155 may be positioned within a range simultaneously operable by a user with one hand. For example, when the first directional key 151 is arranged on the front surface 150-1 of the control apparatus 150 and the second directional key 155 is arranged on the back surface 150-2 of the control apparatus 150, the first directional key 151 may be arranged in a position operable by a thumb of the user, and the second directional key 155 may be arranged in a position operable by an index or middle finger of the user.

In an embodiment, the input interface 1570 may further include a third directional key. For example, the first directional key 151 and the second directional key 155 may both be arranged on the front surface 150-1 of the control apparatus 150, and the third directional key may be arranged on the back surface 150-2 of the control apparatus 150. In this case, when using metaverse content, the user may control the movement direction and the gaze direction of the avatar by turning the control apparatus 150 horizontally and using the first directional key 151 and the second directional key 155, and when using viewing content, the user may operate and use the first directional key 151 and the third directional key positioned on the back surface with one hand by turning the control apparatus 150 vertically.

In an embodiment, the input interface 1570 may further include a sensor capable of identifying motions of the control apparatus 150. In an embodiment, when the input interface 1570 includes the sensor capable of identifying motions, the input interface 1570 may detect a direction of the control apparatus 150 by using the sensor. The control apparatus 150 may transmit, to the electronic apparatus 100, a sensing signal indicating the direction of the control apparatus 150.

The processor 1510 according to an embodiment controls all operations of the control apparatus 150. The processor 1510 may execute the one or more instructions stored in the memory 1530 to control the control apparatus 150 to function.

In an embodiment, the processor 1510 may include, for example, a micro controller unit (MCU).

In an embodiment, when a key input is received from the user via the input interface 1570, the processor 1510 may generate a control signal including a key code instruction corresponding to the input key.

The communication interface 1550 according to an embodiment may include at least one communication module. The communication interface 1550 may connect the control apparatus 150 to the electronic apparatus 100 by using a wired or wireless communication network under control by the processor 1510.

The communication interface 1550 may transmit, to the electronic apparatus 100, a signal corresponding to a user input via the input interface 1570. A signal corresponding to the user input may include a control signal including a key code instruction corresponding to a key selected by the user. The control signal corresponding to the user input may be implemented as Bluetooth type, IR signal type, RF signal type, Wi-Fi type, or the like according to the type of communication module included in the communication interface 1550.

In an embodiment, the communication network 130 may include one or more networks from among Bluetooth, BLE, NFC, IR communication, RF communication, Wi-Fi communication, and wired Ethernet.

In an embodiment, when the electronic apparatus 100 and the control apparatus 150 transmit and receive signals to and from each other by performing IR communication, the control apparatus 150 may generate the control signal including the key code instruction into an IR signal. For example, the control apparatus 150 may generate an IR signal having a unique frequency assigned to the key code instruction for the input key. The control apparatus 150 may transmit the IR signal to the electronic apparatus 100 by using the communication network 130.

In an embodiment, when the electronic apparatus 100 and the control apparatus 150 transmit and receive signals to and from each other by performing BLE communication, in a case where a key input is received from the user, the control apparatus 150 may also generate, into a BLE signal, a control signal including a key code instruction corresponding to the input key. The control apparatus 150 may also transmit the BLE signal to the electronic apparatus 100 via the communication network 130.

However, this is only an embodiment, and the communication network 130 may also include a communication network according to a Wi-Fi communication scheme.

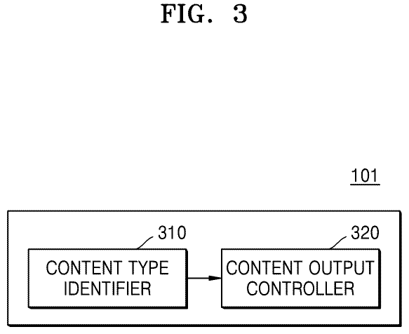

FIG. 3 is an internal block diagram of the processor 101 of the electronic apparatus 100 according to an embodiment.

Referring to FIG. 3, the processor 101 may include a content type identifier 310 and a content output controller 320.

In an embodiment, the content type identifier 310 may identify the type of content currently being output.

For example, when the electronic apparatus 100 receives content via an external device, such as a set-top box or an external game console, and outputs the content, it is difficult for the electronic apparatus 100 to identify the type of content obtained via the external device.

In an embodiment, the content type identifier 310 may obtain metadata for content received via the external device and identify the type of content by using the metadata. In an embodiment, the content type identifier 310 may identify the type of content currently being output by capturing a screen for the received content and identifying characters or logos output on the screen for the content.

In an embodiment, when the electronic apparatus 100 is a smart TV, the electronic apparatus 100 executes an application by using an OS installed therein and an Internet function such that the type of application currently running may be identified. For example, when the electronic apparatus 100 outputs VOD content provided by an OTT service provider called Netflix, the content type identifier 310 may identify that the content currently being output is viewing content by identifying that an application currently running is a Netflix application and that the Netflix application provides VOD content.

Similarly, when the electronic apparatus 100 is currently running a metaverse content application, the content type identifier 310 may identify that the content currently being output is metaverse content by identifying that the application currently running is an application for metaverse content.

In an embodiment, the content type identifier 310 may transmit the type of content currently being output to the content output controller 320.

In an embodiment, the content output controller 320 may receive the type of content from the content type identifier 310 and identify an output mode corresponding to the type of content.

In an embodiment, when the content currently being output is a first type of content, the content output controller 320 may identify a first mode as the output mode. In an embodiment, when a control signal is received from the control apparatus 150, the content output controller 320 may control the content to be output in the first mode.

In an embodiment, when the content currently being output is a second type of content, the content output controller 320 may identify a second mode as the output mode. In an embodiment, when a control signal is received from the control apparatus 150, the content output controller 320 may control the content to be output in the second mode.

In an embodiment, when the content currently being output is a third type of content, the content output controller 320 may identify a third mode as the output mode. In an embodiment, when a control signal is received from the control apparatus 150, the content output controller 320 may control the content to be output in the third mode.

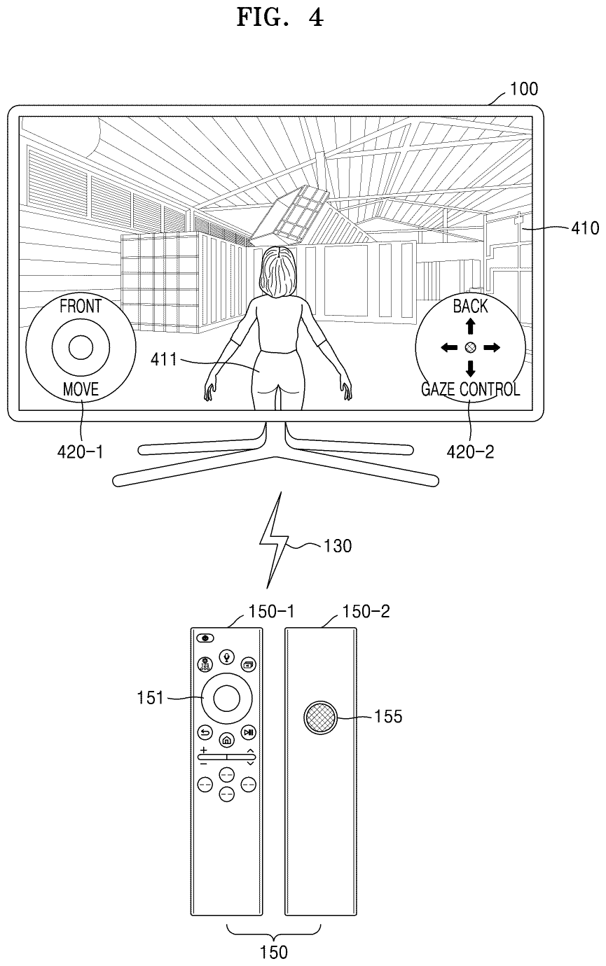

FIG. 4 is a diagram illustrating how illustrating how the electronic apparatus 100 controls content to be output in a first mode based on a control signal from the control apparatus 150, according to an embodiment.

Referring to FIG. 4, the electronic apparatus 100 may output metaverse content 410. The metaverse content 410 may include content representing a virtual world based on a metaverse platform. The metaverse content 410 may include an avatar 411.

In an embodiment, the electronic apparatus 100 may identify that content currently being output is metaverse content. For example, the electronic apparatus 100 may identify that an application currently running is a metaverse content application and, accordingly, identify that the type of content currently being output is metaverse content.

In an embodiment, in response to the content currently being output being the metaverse content, the electronic apparatus 100 may output a guide UI 420 for the metaverse content. The guide UI 420 may include an interface screen for guiding a user in operating the directional keys 151 and 155 provided on the control apparatus 150.

In an embodiment, the electronic apparatus 100 may output the guide UI 420 together with the metaverse content 410. For example, as shown in FIG. 4, the electronic apparatus 100 may display the guide UI 420 on an area of the metaverse content 410 by overlaying the guide UI 420 over the metaverse content 410. The size, output position, transparency, and/or shape of the guide UI 420 may vary.

In an embodiment, the guide UI 420 may include at least one of a first guide UI 420-1 indicating an operation to be performed based on selection of the first directional key 151 and a second guide UI 420-2 indicating an operation to be performed based on selection of the second directional key 155.

In an embodiment, the first guide UI 420-1 and the second guide UI 420-2 may include information indicating which directional key the UI is for. For example, as shown in FIG. 4, the first guide UI 420-1 may include a large circle imitating the shape of the first directional key 151 and may include the word “front”, which is a position where the first directional key 151 is arranged. In contrast, the second guide UI 420-2 may include a small circle imitating the shape of the second directional key 155 and may include the word “back”, which is a position where the second directional key 155 is arranged.

The user may identify that the first guide UI 420-1 is a UI that guides the function of the first directional key 151 by using the large circle and the word “front” included in the first guide UI 420-1. Also, the user may identify that the second guide UI 420-2 is a guide UI for the second directional key 155 by using the small circle and the word “back” included in the second guide UI 420-2.

In an embodiment, the first guide UI 420-1 and the second guide UI 420-2 may include information indicating an operation when a directional key is selected. For example, as shown in FIG. 4, the first guide UI 420-1 may include the word “move”, and the second guide UI 420-2 may include the word “gaze control”.

In an embodiment, the user may use the guide UI 420 to predict operations to be performed when the first directional key 151 and the second directional key 155 provided on the control apparatus 150 are operated. The user may identify that the first directional key 151 is used to move the avatar by using the word “move” included in the first guide UI 420-1. Also, the user may identify that the second directional key 155 is used to control the gaze of the avatar by using the word “gaze control” included in the second guide UI 420-2.

The user may operate the plurality of directional keys 151 and 155 provided on the control apparatus 150 with one hand while looking at the guide UI 420 and the metaverse content 410 output by the electronic apparatus 100 together. For example, the user may operate the first directional key 151 arranged on the front surface 150-1 of the control apparatus 150 with his thumb and simultaneously operate the second directional key 155 arranged on the back surface 150-2 of the control apparatus 150 with his index finger or middle finger.

In response to at least one of the first directional key 151 and the second directional key 155 being selected, the control apparatus 150 may generate a control signal including a key code instruction corresponding to the selected directional key among the first directional key 151 and the second directional key 155.

In an embodiment, the control apparatus 150 may generate a first control signal including a key code instruction corresponding to the first directional key 151. In an embodiment, the control apparatus 150 may generate a first control signal including a key code instruction indicating one of four directions selected from the first directional key 151.

In an embodiment, the control apparatus 150 may generate a second control signal including a key code instruction corresponding to the second directional key 155. In an embodiment, the control apparatus 150 may generate a control signal including a key code instruction indicating one of four directions selected from the second directional key 155.

The control apparatus 150 may transmit at least one of the first control signal and the second control signal to the electronic apparatus 100 via the communication network 130.

In an embodiment, the electronic apparatus 100 may receive, from the control apparatus 150, the first control signal including the key code instruction corresponding to the first directional key 151. In an embodiment, the electronic apparatus 100 may control content to be output in the first mode based on the first control signal. For example, the electronic apparatus 100 may control a movement direction of the avatar 411 based on the first control signal. In response to the user selecting one of right, left, up, and down directions of the first directional key 151, the electronic apparatus 100 may control the avatar 411 to move in one of the right, left, up, and down directions.

In an embodiment, the electronic apparatus 100 may receive, from the control apparatus 150, the second control signal including the key code instruction corresponding to the second directional key 155. In an embodiment, the electronic apparatus 100 may control content to be output in the first mode based on the second control signal. For example, the electronic apparatus 100 may control a gaze direction of the avatar 411 based on the second control signal. In response to the user selecting one of right, left, up, and down directions of the second directional key 155, the electronic apparatus 100 may control the gaze of the avatar 411 to be directed in one of the right, left, up, and down directions. In response to a change in the gaze of the avatar 411, the electronic apparatus 100 may output metaverse content representing a virtual world located in the direction of the gaze of the avatar 411.

In an embodiment, when the user simultaneously operates the first directional key 151 arranged on the front surface 150-1 of the control apparatus 150 and the second directional key 155 arranged on the back surface 150-2 of the control apparatus 150, the electronic apparatus 100 may correspondingly change the movement direction and the gaze direction of the avatar 411.

As described above, according to an embodiment, the user may enjoy the metaverse content 410 by controlling the movement direction and the gaze direction of the avatar 411 by using different keys provided on the control apparatus 150.

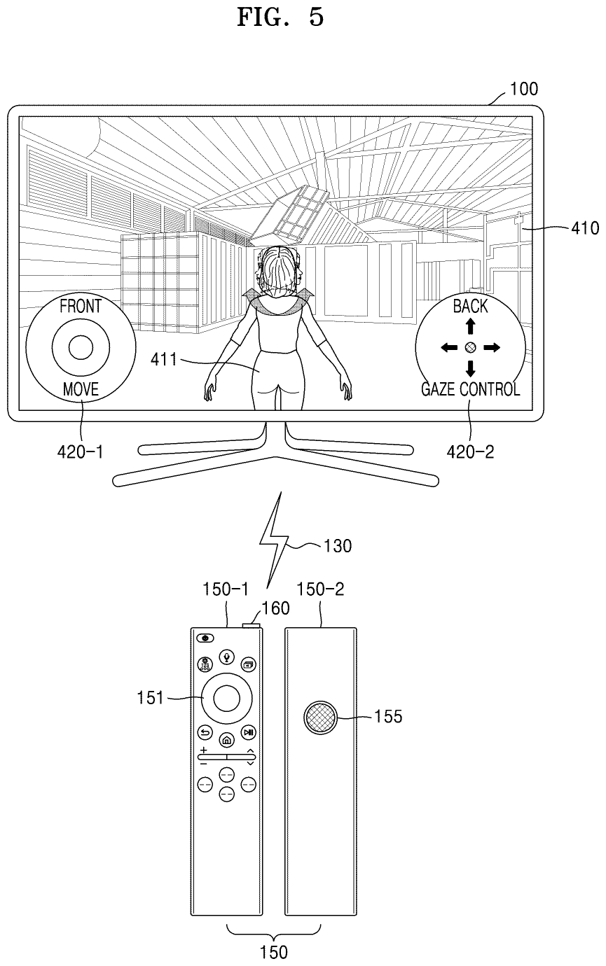

FIG. 5 is a diagram illustrating how the electronic apparatus 100 controls content to be output in a first mode based on a control signal from the control apparatus 150, according to an embodiment.

In an embodiment, the control apparatus 150 may further include a sensor 160 capable of identifying motions. In an embodiment, the sensor 160 may include at least one of a geomagnetic sensor and a gyroscope sensor. In an embodiment, the sensor 160 may be positioned on top of the control apparatus 150, but is not limited thereto.

In an embodiment, the sensor 160 provided on the control apparatus 150 may detect a direction of the control apparatus 150.

When the sensor 160 is a geomagnetic sensor, the geomagnetic sensor may detect a direction of geomagnetic force with respect to the control apparatus 150. When the sensor 160 is a gyroscope sensor, the gyroscope sensor may detect angular speed, which is rotational speed of the control apparatus 150. The gyroscope sensor may also be called an angular speed sensor. The gyroscope sensor may calculate the direction of the control apparatus 150 by converting, into an electrical signal, Coriolis force generated when the control apparatus 150 rotates.

The control apparatus 150 may identify a device position relative to the magnetic north pole by using at least one of the geomagnetic sensor and the gyroscope sensor.

Also, the control apparatus 150 may detect a direction relative to the electronic apparatus 100 by using the sensor 160. For example, when a user suddenly moves the control apparatus 150 up, down, left, or right within a reference time based on the direction toward the electronic apparatus 100, the geomagnetic sensor and/or the gyroscope sensor may detect that the direction of the control apparatus 150 has suddenly changed within the reference time.

In an embodiment, the control apparatus 150 may transmit, to the electronic apparatus 100, a sensing signal obtained via the sensor 160.

In an embodiment, when the sensing signal is received from the control apparatus 150, the electronic apparatus 100 may control an action of the avatar 411 based on the sensing signal. An action performed based on the sensing signal obtained via the sensor 160 provided on the control apparatus 150 may vary according to the type of metaverse content application, the material of metaverse content, or the situation.

For example, the electronic apparatus 100 may control the avatar 411 to express itself based on the sensing signal. For example, when the user moves the control apparatus 150 up and down, the electronic apparatus 100 may control the head of the avatar 411 to nod back and forth based on the sensing signal received from the control apparatus 150. This may match the avatar 411 expressing positive intent in an action or situation.

Also, when the user moves the control apparatus 150 left and right, the electronic apparatus 100 may control the avatar 411 to shake its head left and right based on the sensing signal received from the control apparatus 150. This may match the avatar 411 expressing negative intent in an action or situation. FIG. 5 illustrates an embodiment in which the avatar 411 shakes its head left and right when the user moves the control apparatus 150 left and right.

In another example, when the metaverse content is about war and the avatar is a warrior fighting on a battlefield, in a case where the user moves the control apparatus 150 up and down, the electronic apparatus 100 may control the warrior to swing his sword up and down based on the sensing signal received from the control apparatus 150. Also, when the user moves the control apparatus 150 left and right, the electronic apparatus 100 may control the warrior to swing his sword left and right based on the sensing signal received from the control apparatus 150.

As described, according to an embodiment, the control apparatus 150 may identify the direction of the control apparatus 150 by using the sensor 160 and transmit the same to the electronic apparatus 100.

Also, according to an embodiment, the electronic apparatus 100 may control the action of the avatar 411 in various forms based on the sensing signal received from the control apparatus 150.

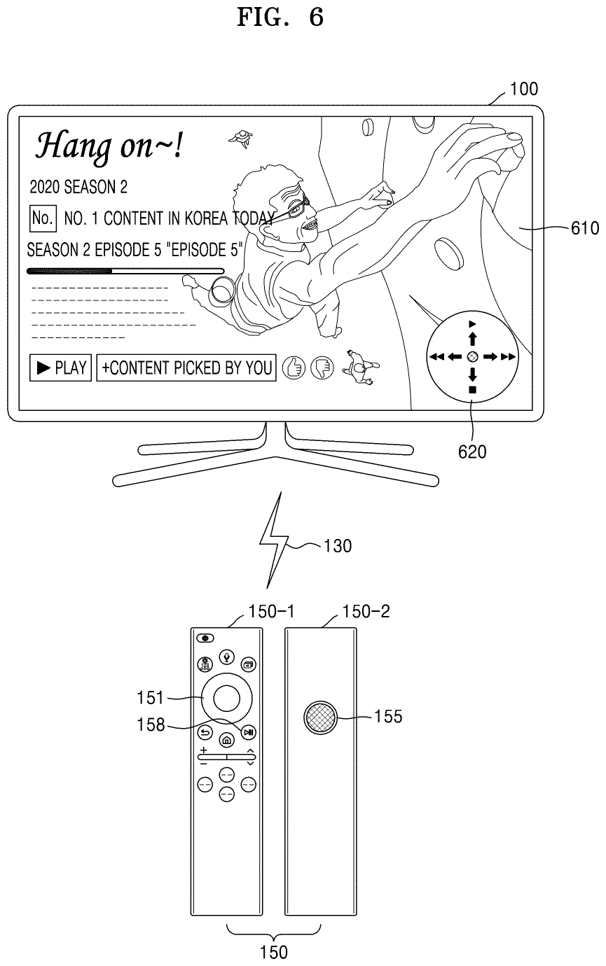

FIG. 6 is a diagram illustrating how the electronic apparatus 100 controls content to be output in a second mode based on a control signal from the control apparatus 150, according to an embodiment.

Referring to FIG. 6, the electronic apparatus 100 may output viewing content 610.

In an embodiment, the electronic apparatus 100 may identify that content currently being output is viewing content. In an embodiment, in response to the content currently being output being the viewing content, the electronic apparatus 100 may output a guide UI for the viewing content.

FIG. 6 illustrates an embodiment in which the electronic apparatus 100 outputs preview content among the viewing content 610.

A user may know that, when the first directional key 151 is operated, an object included in the content is selected. Accordingly, in an embodiment, when the electronic apparatus 100 outputs the viewing content, the electronic apparatus 100 may not output a first guide UI for guiding an operation according to operation of the first directional key 151, but may output only a second guide UI 620 for guiding an operation according to operation of the second directional key 155. However, this is only an embodiment, and the electronic apparatus 100 may also output the first guide UI for guiding the operation according to the operation of the first directional key 151 together with the second guide UI 620.

In an embodiment, the electronic apparatus 100 may output the second guide UI 620 together with the viewing content 610. For example, as shown in FIG. 6, the electronic apparatus 100 may display the second guide UI 620 on an area of the viewing content 610. The size, output position, transparency, and/or shape of the second guide UI 620 may vary.

In an embodiment, the second guide UI 620 may include various types of information indicating the position of the control apparatus 150 at which the second directional key 155 is arranged, or indicating that the UI is for the second directional key 155. For example, as shown in FIG. 6, the second guide UI 620 may include a small circle imitating the shape of the second directional key 155. However, the present disclosure is not limited thereto, and in order to indicate that the second directional key 155 is positioned on the back of the control apparatus 150, the second guide UI 620 may also include the word “back” or various shapes indicating the back of the control apparatus 150.

The user may identify that the second guide UI 620 is for the second directional key 155 by using the information included in the second guide UI 620. For example, in FIG. 6, the user may see a small circle imitating the shape of the second directional key 155 included in the second guide UI 620 and identify that the second guide UI 620 is a guide UI for the second directional key 155.

In an embodiment, the second guide UI 620 may include information indicating an operation when a directional key is selected. For example, as shown in FIG. 6, the second guide UI 620 may include symbols, representing pause, play, fast-forward, and fast-rewind, at four directional positions around the small circle, respectively.

In an embodiment, the user may identify that the second directional key 155 is used to select pause, play, fast-forward, or fast-rewind by using the symbols included in the second guide UI 620.

The user may cause a function displayed on the second guide UI 620 to be executed by operating the second directional key 155 while looking at the second guide UI 620 and the viewing content 610 output by the electronic apparatus 100 together.

Also, the user may operate the first directional key 151 to select an object included in the content.

The control apparatus 150 may generate a control signal in response to at least one of the first directional key 151 and the second directional key 155 being selected. The control apparatus 150 may generate a first control signal including a key code instruction corresponding to a direction selected from the first directional key 151. Also, the control apparatus 150 may generate a second control signal including a key code instruction corresponding to a direction selected from the second directional key 155. The control apparatus 150 may transmit at least one of the first control signal and the second control signal to the electronic apparatus 100.

In an embodiment, based on receiving at least one of the first control signal and the second control signal while the viewing content 610 is output, the electronic apparatus 100 may control the output of the viewing content 610 in the second mode.

In an embodiment, controlling the output of the viewing content 610 in the second mode by the electronic apparatus 100 may include, when the first control signal is received, an operation of selecting, based on the first control signal, one of a plurality of objects included in the viewing content 610 currently output on a screen. Also, in an embodiment, controlling the output of the viewing content 610 in the second mode by the electronic apparatus 100 may include, when the second control signal is received, performing an operation guided by the second guide UI 620 based on the second control signal.

In an embodiment, the electronic apparatus 100 having received the second control signal for the second directional key 155 from the control apparatus 150 may immediately perform the operation guided by the second guide UI 620. For example, as shown in FIG. 6, in a state in which the preview content is output on the electronic apparatus 100, when the user wishes to view content introduced in the preview content from a middle point, the user may select a play button 158 provided on the control apparatus 150, enters the content displayed by the preview content, and then may select the play button 158 or another button, such as a fast-forward button, to cause the electronic apparatus 100 to play the content from the middle point.

However, according to the present embodiment, the user may control the content to fast-forward by selecting only the right button of the second directional key 155 as guided by the second guide UI 620. For example, according to an embodiment, the user may control the electronic apparatus 100 to perform an operation by pressing the second directional key 155 only once, without pressing buttons provided on the control apparatus 150 several times.

As described above, according to an embodiment, the user may conveniently control the viewing content by using the second directional key 155 provided on the control apparatus 150.

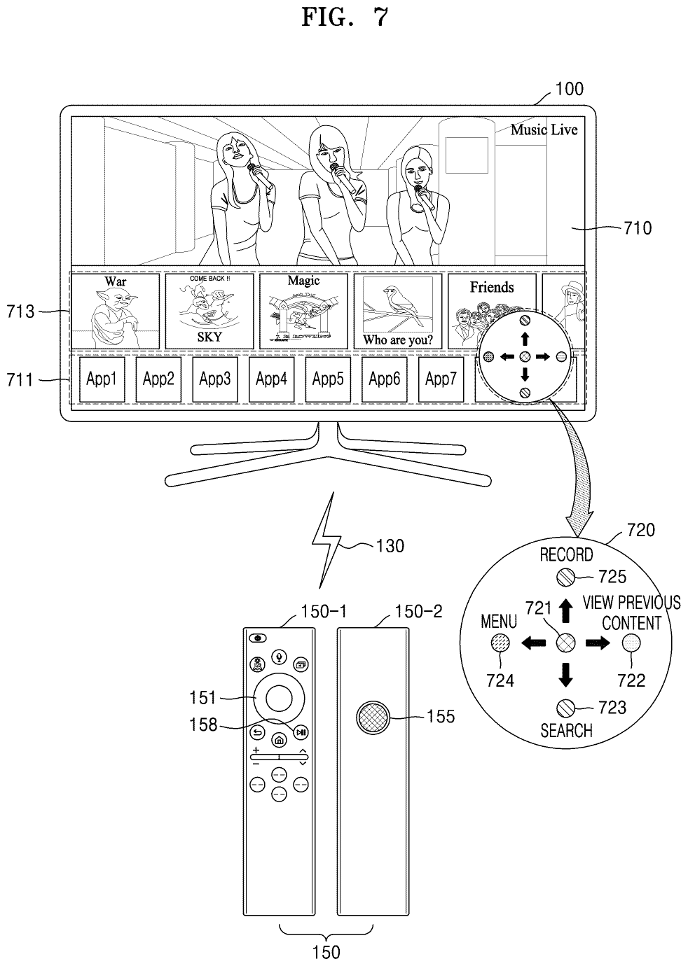

FIG. 7 is a diagram illustrating how the electronic apparatus 100 controls content to be output in a second mode based on a control signal from the control apparatus 150, according to an embodiment.

Referring to FIG. 7, the electronic apparatus 100 may output viewing content 710.

In an embodiment, the electronic apparatus 100 may identify that content currently being output is the viewing content 710. In an embodiment, in response to the content currently being output being the viewing content 710, the electronic apparatus 100 may output a guide UI for the viewing content 710.

FIG. 7 illustrates an embodiment in which the electronic apparatus 100 outputs a default screen with the viewing content 710. In an embodiment, the default screen may include a home screen that is first displayed when the power of the electronic apparatus 100 is turned on. The default screen may vary according to the manufacturer of the electronic apparatus 100, whether the electronic apparatus 100 is a smart TV, or the type of set-top box connected to the electronic apparatus 100. The default screen may be one of the viewing content 710.

FIG. 7 illustrates an example of a default screen first displayed when the electronic apparatus 100 is a smart TV and the electronic apparatus 100 is turned on.

Referring to FIG. 7, the default screen may include application tiles 711. In an embodiment, the application tiles 711 represents executable applications in the form of tiles and may include at least one of various applications, for example, an application provided by an OTT service provider or an IPTV service provider, a shopping application, a music application, and a metaverse content application. A user may select a desired application from among the application tiles 711 to run the application.

Also, the default screen may include various pieces of VOD content 713 in the form of thumbnails. The VOD content 713 may be one of the viewing content 710. The default screen may include, in the form of a thumbnail, content title, or the like, at least one of currently viewable content, popular content, content that the user has viewed in the past, and recommended content recommended by the electronic apparatus 100.

In an embodiment, the viewing content 710 may include various objects. For example, the application tiles 711 or the VOD content 713 included in the default screen may all be objects selectable by using the control apparatus 150. The user may adjust the position of a cursor by using the first directional key 151 provided on the control apparatus 150. The cursor may be a marker that indicates an input position on a screen. The user may select a desired application or VOD content from among a plurality of objects included in the viewing content 710 by using the first directional key 151.

In an embodiment, based on receiving a first control signal from the control apparatus 150 while the viewing content 710 is output, the electronic apparatus 100 may control the content to be output in the second mode.

In an embodiment, the electronic apparatus 100 may select one of the plurality of objects included in the viewing content 710 currently being output on the screen by changing the position of the cursor based on the first control signal.

In an embodiment, the user may cause an operation to be immediately executed by using the second directional key 155. An operation or a function corresponding to each of four directions of the second directional key 155 may vary according the type of application and may also vary according to the material of the viewing content 710 currently being output on the screen.

In an embodiment, while the viewing content 710 is output, the electronic apparatus 100 may output a second guide UI 720 for guiding an operation according to operation of the second directional key 155. The user may identify which function is to be executed when the second directional key 155 is selected by looking at the second guide UI 720 output on the screen.

In an embodiment, the electronic apparatus 100 may output the second guide UI 720 together with the viewing content 710. As shown in FIG. 7, the electronic apparatus 100 may display the second guide UI 720 by overlaying the second guide UI 720 over an area of the viewing content 710. The size, output position, transparency, and/or shape of the second guide UI 720 may vary.

In an embodiment, the second guide UI 720 includes information indicating the shape of the second directional key 155 or the position where the second directional key 155 is arranged, and may thus indicate that the second guide UI 720 is for the second directional key 155.

In an embodiment, the second guide UI 720 may include information indicating an operation or a function to be executed when each of the four directions of the second directional key 155 provided on the control apparatus 150 is selected. For example, the second guide UI 720 may be expressed in color. As shown in FIG. 7, the second guide UI 720 may include a blue circle 722, a yellow circle 723, a green circle 724, and a red circle 725 at four directional positions around a shape 721 imitating the second directional key 155, respectively.

In an embodiment, the second guide UI 720 may further include operations or functions corresponding to the four directions along with colors at the four directional positions, respectively. For example, as shown in FIG. 7, the second guide UI 720 may include information indicating functions corresponding to directions, such as “view previous content”, “search”, “menu”, and “record”, along with colors at the four directional positions, respectively. This may mean that a function corresponding to the blue circle 722 is a function to retrieve content that was just previously viewed, and that a function corresponding to the yellow circle 723 is a search window function. Also, this may mean that a function corresponding to the green circle 724 is a menu item selection function, and a function corresponding to the red circle 725 is a recording function. However, this is only an embodiment, and the functions or operations corresponding to the colors positioned in the four directions may vary according to the type of the viewing content 710 currently being output on the screen or functions supported by the electronic apparatus 100.

In an embodiment, the user may cause a function corresponding to the selected color to be executed by selecting one of the four directions included in the second directional key 155 by using information indicating direction-based colors included in the second guide UI 720 and/or operations corresponding to the colors.

In an embodiment, the control apparatus 150 may generate a control signal including a key code instruction corresponding to the direction selected by the user among the four directions included in the second directional key 155. The control apparatus 150 may transmit the generated control signal to the electronic apparatus 100.

In an embodiment, the electronic apparatus 100 may receive, from the control apparatus 150, a second control signal corresponding to the second directional key 155. In an embodiment, based on having received the second control signal while the viewing content 710 is output, the electronic apparatus 100 may control the content to be output in the second mode.

For example, when the user selects the right direction among the four directions included in the second directional key 155 and the blue circle 722 is selected from among the four colors included in the second guide UI 720, the electronic apparatus 100 may retrieve content that was just previously output by the electronic apparatus 100 and immediately output the content on the screen.

As shown in FIG. 7, in a state in which the default screen is output on the electronic apparatus 100, in order to again view the content that was previously viewed, the user may find an object of the content that was being viewed and select the object on the default screen by using the first directional key 151, and select the play button 158 provided on the control apparatus 150 again to play the selected object. However, according to the present disclosure, in a state in which the default screen is output, the user may immediately view the content that was just previously viewed by selecting the right direction among the four directions included in the second directional key 155. For example, the user may cause a desired function to be immediately executed by operating the second directional key 155 only once without having to operate the control apparatus 150 several times.

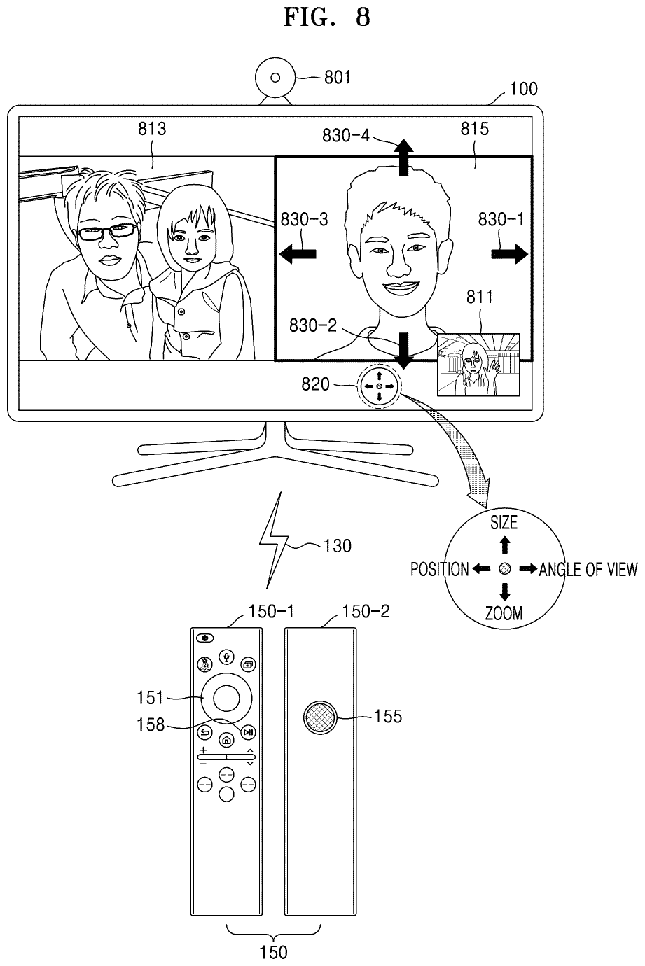

FIG. 8 is a diagram illustrating how the electronic apparatus 100 controls content to be output in a third mode based on a control signal from the control apparatus 150, according to an embodiment.

In an embodiment, the electronic apparatus 100 may perform a video call function. In order for the video call function to be performed, the electronic apparatus 100 may include a camera 801.

In an embodiment, the camera 801 may be integrated into the electronic apparatus 100 or may be a separate device from the electronic apparatus 100 and connected to the electronic apparatus 100. The camera 801 may be arranged in an area of the electronic apparatus 100. For example, as shown in FIG. 8, the camera 801 may be arranged on top of the electronic apparatus 100 and obtain a real-time image of a user by capturing an image of the user.

In an embodiment, when the user executes a video call application by controlling the electronic apparatus 100, the electronic apparatus 100 may output video call content 810 according to the execution of the video call application on a screen.

In an embodiment, the electronic apparatus 100 may communicate with a counterpart terminal in response to the video call application being executed. The electronic apparatus 100 may transmit a video captured by using the camera 801 to the counterpart terminal in real time and may also receive a video from the counterpart terminal in real time.

In an embodiment, the electronic apparatus 100 may output, in multi-view through partial screens a user screen obtained by using the camera 801 and a counterpart screen received from the counterpart terminal. One or a plurality of partial screens may be provided according to the number of counterpart terminals. For example, as shown in FIG. 8, the video call content 810 may include a user screen 811 obtained by using the camera 801, a first counterpart screen 813 showing a first counterpart, and a second counterpart screen 815 showing a second counterpart. The user screen 811, the first counterpart screen 813, and the second counterpart screen 815 may each be an object.

In an embodiment, the user may control the video call content 810 by using the control apparatus 150. In an embodiment, based on receiving a signal from the control apparatus 150 while the video call content 810 is output, the electronic apparatus 100 may control the content to be output in the third mode.

In an embodiment, the controlling of the content to be output in the third mode may include controlling a movement direction of a focus for selecting one screen among multi-view included in the video call content 810 based on the first control signal according to selection of the first directional key 151. In an embodiment, the user select a desired screen from among a plurality of objects, for example, a plurality of screens, included in the video call content 810 by adjusting the position of a cursor or a focus by using the first directional key 151 provided on the control apparatus 150. For example, when the user selects the second counterpart screen 815 from among the plurality of screens by operating the first directional key 151, the electronic apparatus 100 may indicate that the second counterpart screen 815 is focused by displaying the border of the second counterpart screen 815 in a thick color, as shown in FIG. 8.

In an embodiment, the controlling of the content to be output in the third mode may include adjusting at least one of the size, position, angle of view, and zoom function of the selected screen based on a second control signal according to selection of the second directional key 155.

In an embodiment, in response to content currently being output being the video call content 810, the electronic apparatus 100 may generate a guide UI for the video call content 810 and output the guide UI.

In an embodiment, the electronic apparatus 100 may output a second guide UI 820 together with the video call content 810. For example, as shown in FIG. 8, the electronic apparatus 100 may display the second guide UI 820 on an area of the screen. The size, output position, transparency, and/or shape of the second guide UI 820 may vary.

In an embodiment, the second guide UI 820 may include information indicating that the second guide UI 820 is for control of the second directional key 155. For example, as shown in FIG. 8, the second guide UI 820 may include a small circle imitating the shape of the second directional key 155.

In an embodiment, the second guide UI 820 may include information indicating an operation when a directional key is selected. For example, as shown in FIG. 8, the second guide UI 820 may include, along with arrows indicating four directions around the small circle, the words “size”, “position”, “angle of view”, and “zoom” around the directions. However, this is only an embodiment, and functions or operations corresponding to the four directions may vary according to the situation.

In an embodiment, the user may identify that the second directional key 155 is used to adjust the size, position, angle of view, and zoom of the screen by using symbols or characters included in the second guide UI 820.

The user may operate the second directional key 155 to cause a function displayed on the second guide UI 820 to be executed while looking at the second guide UI 820 and the video call content 810 output by the electronic apparatus 100 together.

In an embodiment, based on one of the four directions included in the second directional key 155 being selected, the electronic apparatus 100 may adjust the position of the selected screen. For example, when the user selects a left button of the second directional key 155, the electronic apparatus 100 may change the position of the selected screen to another position by using the first directional key 151. When the user selects the left button of the second directional key 155 once, the electronic apparatus 100 may adjust the position of the selected screen, for example, the second counterpart screen 815 in the above example, such that the positions of the first counterpart screen 813 on the left and the second counterpart screen 815 may be switched. When the user selects the left button of the second directional key 155 again, the electronic apparatus 100 may allow the positions of the second counterpart screen 815 and the user screen 811 to be switched. However, this is only an embodiment, and the electronic apparatus 100 may change the position of the selected screen by using various methods.

In an embodiment, based on one of the four directions included in the second directional key 155 being selected, the electronic apparatus 100 may adjust the size of the selected screen. For example, based on the user selecting the up button of the second directional key 155, the electronic apparatus 100 may gradually enlarge the size of the second counterpart screen 815. In this case, the electronic apparatus 100 may display that the size of the selected screen is increasing by outputting UIs 830-1, 830-2, 830-3, and 830-4 such as arrows shown in FIG. 8. When the user continues to select the up button of the second directional key 155 even in a state in which the size of the selected screen has increased to a certain size, the electronic apparatus 100 may gradually reduce the size of the selected screen. The electronic apparatus 100 may output an UI indicating that the size of the selected screen is decreasing, for example, an arrow pointing inward from around the selected screen.

In an embodiment, when one of the four directions included in the second directional key 155 is selected in a state in which the user screen 811 is selected, the electronic apparatus 100 may perform a function of adjusting the position or size of the user screen 811 and may also execute a zoom function or a wide-angle function. For example, in an embodiment, in a state in which the user screen 811 is selected, the user may select a down button among the four directions included in the second directional key 155. In this case, the electronic apparatus 100 may adjust a capturing area for the user by zooming in or zooming out by adjusting the focal length of a lens included in the camera 801.

In an embodiment, when the user selects the right button of the second directional key 155 in a state in which the user screen 811 is selected, the electronic apparatus 100 may adjust the angle of view of the user screen 811. For example, the electronic apparatus 100 may allow an area to the left or right of the current screen to be visible on the user screen 811 by adjusting the range that may be captured by the lens by adjusting the position of the lens of the camera 801.

As described above, according to an embodiment, the user may conveniently adjust the size, position, angle of view, or zoom of the screen in the video call content 810 by operating the second directional key 155 as guided by the second guide UI 820.

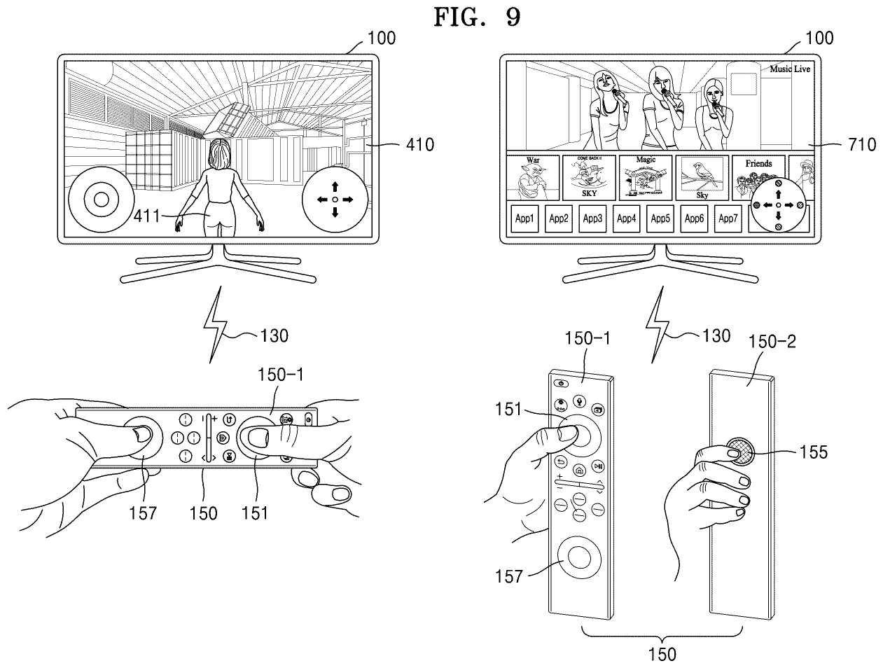

FIG. 9 shows a case where the control apparatus 150 includes three or more directional keys, according to an embodiment.

Referring to FIG. 9, the control apparatus 150 may further include a third directional key 157 in addition to the first directional key 151 and the second directional key 155.

In an embodiment, the third directional key 157 may be arranged on the front surface 150-1 of the control apparatus 150 similarly to the first directional key 151. In an embodiment, because the first directional key 151 and the third directional key 157 are arranged at a certain distance or more apart from each other, when a user uses the control apparatus 150 by positioning the same horizontally, the first directional key 151 and the third directional key 157 may be arranged at positions convenient for operation with the thumbs of both hands of the user.

In an embodiment, the electronic apparatus 100 may output the metaverse content 410.

In an embodiment, the electronic apparatus 100 may control the content to be output in a first mode in response to outputting the metaverse content 410.

In an embodiment, while the electronic apparatus 100 outputs the metaverse content 410, only the first directional key 151 and the third directional key 157 provided on the control apparatus 150 may be activated. In order to control the metaverse content 410, the user may control the avatar 411 appearing in the metaverse content 410 by rotating the control apparatus 150 horizontally and operating the first directional key 151 and the third directional key 157 provided on the front surface 150-1 of the control apparatus 150 with both thumbs.

In an embodiment, while the metaverse content 410 is output, the electronic apparatus 100 may output, to the user, a guide UI indicating a function when the first directional key 151 and the third directional key 157 are operated.

The user may control a movement direction of the avatar 411 by operating the first directional key 151 while looking at the guide UI. The electronic apparatus 100 may receive, from the user, a control signal based on selection of one direction among the four directions of the first directional key 151, and accordingly, control the avatar 411 to move in the selected direction among the four directions.

In an embodiment, the electronic apparatus 100 may receive, from the control apparatus 150, a control signal including a key code instruction corresponding to the third directional key 157. In an embodiment, the electronic apparatus 100 may control a gaze direction of the avatar 411 based on the control signal corresponding to the third directional key 157. In response to the user selecting one of right, left, up, and down directions of the third directional key 157, the electronic apparatus 100 may control the gaze of the avatar 411 to be directed in one of the right, left, up, and down directions. In response to the gaze of the avatar 411, the electronic apparatus 100 may output content representing a virtual world located in the direction the gaze of the avatar 411 is directed.

In an embodiment, the electronic apparatus 100 may output the viewing content 710.

In an embodiment, the electronic apparatus 100 may control the content to be output in a second mode in response to outputting the viewing content 710.

In an embodiment, while the electronic apparatus 100 outputs the viewing content 710, only the first directional key 151 provided on the front surface 150-1 of the control apparatus 150 and the second directional key 155 provided on the back surface 150-2 of the control apparatus 150 may be activated, and the third directional key 157 may be deactivated.

In an embodiment, while the viewing content 710 is output, the electronic apparatus 100 may output, to the user, a guide UI indicating a function when at least one of the first directional key 151 and the second directional key 155 is operated.

In order to control the viewing content 710, the user may hold the control apparatus 150 vertically and operate the first directional key 151 provided on the front surface 150-1 of the control apparatus 150 and the second directional key 155 provided on the back surface 150-2 by holding the control apparatus 150 with one hand.

For example, the user may select one of objects included in the viewing content 710 by adjusting a movement direction of a focus by operating the first directional key 151. Also, the user may control the content to be output in the second mode by causing a function corresponding to the control signal to be performed by operating the second directional key 155, wherein the function may be performed on a screen for the viewing content 710 currently being output.

As described above, according to an embodiment, the control apparatus 150 may include three or more directional keys. When using the metaverse content 410 and the viewing content 710 with the electronic apparatus 100, the user may conveniently control different types of content with one control apparatus 150 by operating a plurality of directional keys provided on the control apparatus 150.

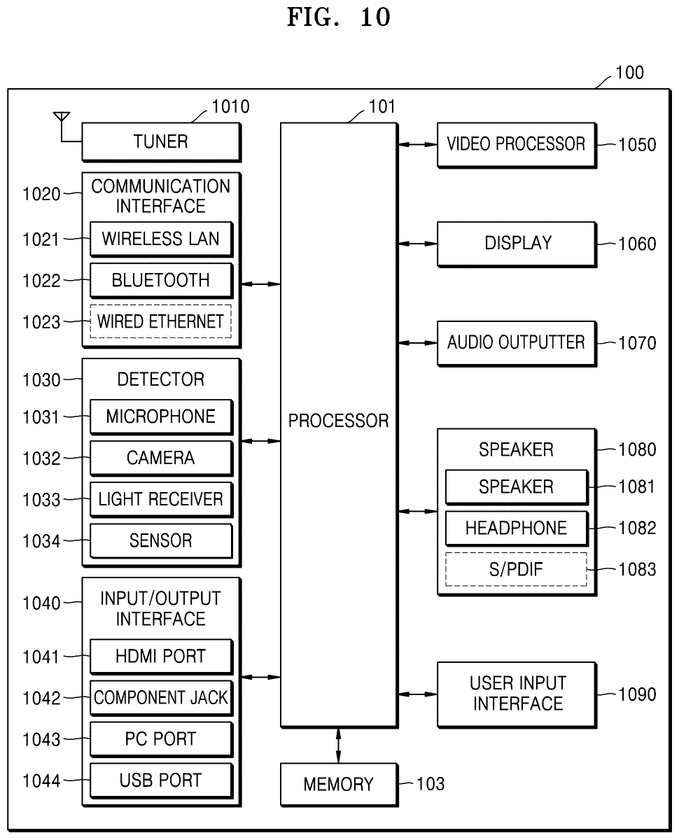

FIG. 10 is an internal block diagram of the electronic apparatus 100 according to an embodiment.

The electronic apparatus 100 of FIG. 10 may be an example of the electronic apparatus 100 of FIG. 2. Accordingly, reference may be made to FIG. 2 and the corresponding descriptions for implementation details.

Referring to FIG. 10, the electronic apparatus 100 may include a processor 101 and a memory 103. The processor 101 and the memory 103 included in the electronic apparatus 100 perform the same operations as the processor 101 and the memory 103 included in the electronic apparatus 100 of FIG. 2, and thus, the same reference numerals are used.

In an embodiment, the electronic apparatus 100 may include, in addition to the processor 101 and the memory 103, a tuner 1010, a communication interface 1020, a detector 1030, an input/output interface 1040, a video processor 1050, a display 1060, an audio processor 1070, an audio outputter 1080, and a user input interface 1090.

The tuner 1010 may tune and then select only a frequency of a channel that is to be received by the electronic apparatus 100 from among many radio wave components via amplification, mixing, resonance, or the like of broadcasting content in a wired or wireless manner. The content received via the tuner 1010 may be decoded and divided into audio, video, and/or additional information. The divided audio, video, and/or additional information may be stored in the memory 103 under control by the processor 101.

In an embodiment, the communication interface 1020 may connect the electronic apparatus 100 to a peripheral device, an external device, a server, a mobile terminal, etc. under the control by the processor 101. The communication interface 1020 may include at least one communication module capable of performing wireless communication. The communication interface 1020 may include at least one of a wireless LAN module 1021, a Bluetooth module 1022, and wired Ethernet 1023 according to the performance and structure of the electronic apparatus 100.

The Bluetooth module 1022 may receive a Bluetooth signal transmitted from a peripheral device according to a Bluetooth communication standard. The Bluetooth module 1022 may include a BLE communication module and may receive a BLE signal. The Bluetooth module 1022 may continuously or temporarily scan for the BLE signal to detect whether the BLE signal is received. The wireless LAN module 1021 may transmit or receive a Wi-Fi signal to or from a peripheral device according to a Wi-Fi communication standard.

The detector 1030 may receive speech of a user, an image of the user, or an interaction with the user and may include a microphone 1031, a camera 1032, a light receiver 1033, and a sensor 1034. The microphone 1031 may receive an audio signal including uttered speech of the user or noise, convert the received audio signal into an electrical signal, and output the electrical signal to the processor 101.

The camera 1032 may include a sensor and a lens and may capture an image formed on a screen and transmit the image to the processor 101.

In an embodiment, the camera 1032 may capture an image of a user in response to a video call application being executed. In an embodiment, the camera 1032 may adjust the angle of view for capturing an image of the user or zoom in or zoom out based on a control signal according to control of the second directional key 155 from the user.

The light receiver 1033 may receive an optical signal (including a control signal). The light receiver 1033 may receive an optical signal corresponding to a user input (e.g., a touch, a press, a touch gesture, a speech, or a motion) from the control apparatus 150 such as a remote controller or a mobile phone.

The input/output interface 1040 may receive a video (e.g., a dynamic image signal or a still image signal), audio (e.g., a speech signal or a music signal), and additional information from an external device under the control by the processor 101.

The input/output interface 1040 may include at least one of a high-definition multimedia interface (HDMI) port 1041, a component jack 1042, a PC port 1043, and a USB port 1044. The input/output interface 1040 may include a combination of the HDMI port 1041, the component jack 1042, the PC port 1043, and the USB port 1044.

The video processor 1050 may process image data to be displayed by the display 1060 and may perform, on the image data, various image processing operations such as decoding, rendering, scaling, noise filtering, frame rate conversion, and resolution conversion.

The display 1060 may output, on the screen, content received from a broadcasting station, content received from an external server or an external device such as an external storage medium, or content provided by various applications such as an OTT service provider or a metaverse content provider. The content is a media signal and may include a video signal, an image, or a text signal.

In an embodiment, the display 1060 may output a guide UI indicating an operation or a function to be performed when the first directional key 151 or the second directional key 155 is selected. In an embodiment, the display 1060 may output at least one of a first guide UI indicating a corresponding operation when the first directional key 151 is selected, and a second guide UI indicating a corresponding operation when the second directional key 155 is selected.

In an embodiment, when the control apparatus 150 further includes the third directional key 157, the display 1060 may also output a guide UI that guides an operation when the third directional key 157 is selected.

The audio processor 1070 processes audio data. The audio processor 1070 may perform various processing, such as decoding, amplification, noise filtering, etc., on the audio data.

The audio outputter 1080 may output audio included in content received via the tuner 1010, audio input via the communication interface 1020 or the input/output interface 1040, and audio stored in the memory 103 under the control by the processor 101. The audio outputter 1080 may include at least one of a speaker 1081, a headphone 1082, and a Sony/Philips digital interface (S/PDIF) output terminal 1083.

In an embodiment, the audio outputter 1080 may adjust the volume of audio output under control by a remote control apparatus or the processor 101.

The user input interface 1090 may receive a user input for controlling the electronic apparatus 100. The user input interface 1090 may include various types of user input devices including a touch panel that senses a touch of a user, a button that receives a push operation of the user, a wheel that receives a rotation operation of the user, a keyboard, a dome switch, a microphone for speech recognition, and a motion sensor that senses a motion, but is not limited thereto. In an embodiment, when the electronic apparatus 100 is controlled by using the control apparatus 150, the user input interface 1090 may receive a control signal received from the control apparatus 150.

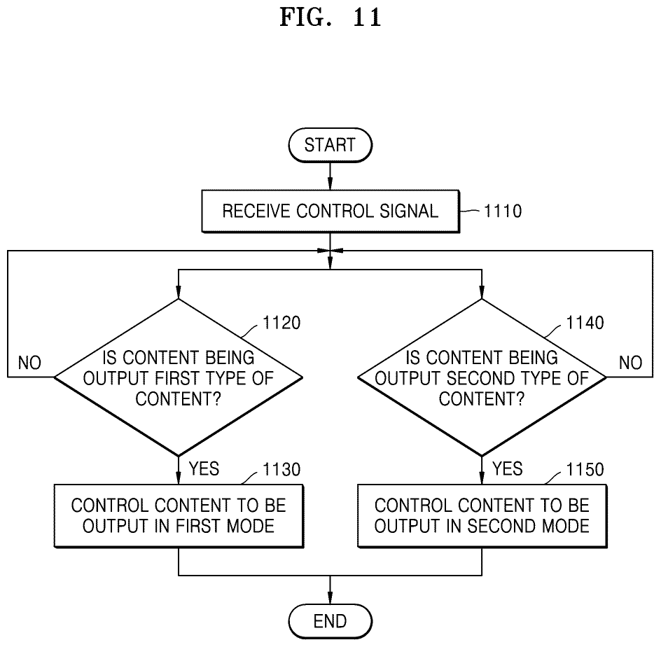

FIG. 11 is a flowchart illustrating an operating method of the electronic apparatus 100, according to an embodiment.

Referring to FIG. 11, the electronic apparatus 100 may receive a control signal (operation 1110).

In an embodiment, the electronic apparatus 100 may receive, from the control apparatus 150, a control signal including instructions corresponding to a plurality of keys provided on the control apparatus 150.

In an embodiment, the control signal may include at least one of a first control signal based on selection of the first directional key 151 provided on the control apparatus 150 and a second control signal based on selection of the second directional key 155 different from the first directional key 151.

In an embodiment, the electronic apparatus 100 may identify the type of content currently being output. In an embodiment, the electronic apparatus 100 may identify whether the content being output is a first type of content (operation 1120). The first type of content may include, for example, metaverse content. For example, when an application currently running is a metaverse application, the electronic apparatus 100 may identify that the content currently being output is metaverse content.

In an embodiment, when the content output by the electronic apparatus 100 is the first type of content, the electronic apparatus 100 may control the content to be output in a first mode (operation 1130).

In an embodiment, the electronic apparatus 100 may identify whether the content being output is a second type of content (operation 1140). The second type of content may include, for example, viewing content.

In an embodiment, when the content output by the electronic apparatus 100 is the second type of content, the electronic apparatus 100 may control the content to be output in a second mode (operation 1150).

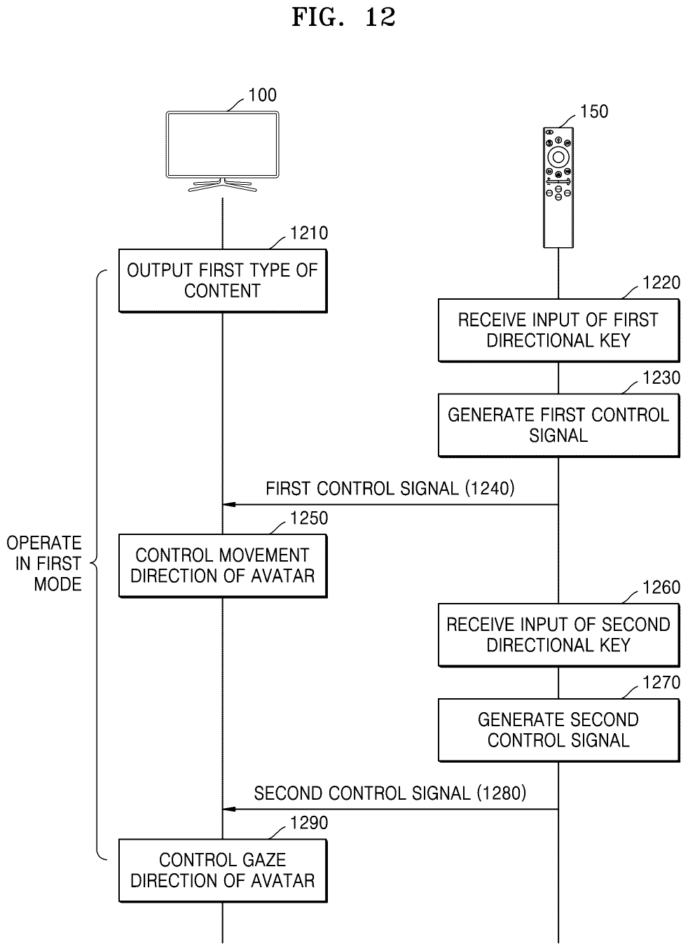

FIG. 12 is a diagram illustrating how the electronic apparatus 100 controls content to be output in a first mode based on a control signal from the control apparatus 150, according to an embodiment.

Referring to FIG. 12, the electronic apparatus 100 may communicate with the control apparatus 150.

In an embodiment, the electronic apparatus 100 may output a first type of content (operation 1210). The first type of content may include metaverse content.

In an embodiment, when a control signal is received while the first type of content is output, the electronic apparatus 100 may control the content to be output in the first mode.

In an embodiment, the electronic apparatus 100 may output, along with the first type of content, a guide UI indicating an operation to be performed based on selection of a directional key. A user may operate the directional key by using the guide UI.

The user may select the first directional key 151 provided on the control apparatus 150. In an embodiment, the control apparatus 150 may receive an input of the first directional key from the user (operation 1220). The control apparatus 150 may generate a first control signal in response to the first directional key 151 being selected (operation 1230). The first control signal may include a control signal including a key code instruction corresponding to one of four directions of the first directional key 151.

In an embodiment, the control apparatus 150 may transmit the first control signal to the electronic apparatus 100 (operation 1240).

In an embodiment, the electronic apparatus 100 may control a movement direction of an avatar based on the first control signal (operation 1250). In an embodiment, the electronic apparatus 100 may control the movement direction of the avatar according to a direction selected by the user using the first directional key 151.

The user may select the second directional key 155 provided on the control apparatus 150. In an embodiment, the control apparatus 150 may receive an input of the second directional key from the user (operation 1260). The control apparatus 150 may generate a second control signal in response to the second directional key 155 being selected (operation 1270). The second control signal may include a control signal including a key code instruction corresponding to one of four directions of the second directional key 155.

In an embodiment, the control apparatus 150 may transmit the second control signal to the electronic apparatus 100 (operation 1280).

In an embodiment, the electronic apparatus 100 may control a gaze direction of the avatar based on the second control signal (operation 1290). In an embodiment, the electronic apparatus 100 may output metaverse content representing a virtual reality toward which the gaze of the avatar is directed by controlling the gaze direction of the avatar according to a direction selected by the user using the second directional key 155.

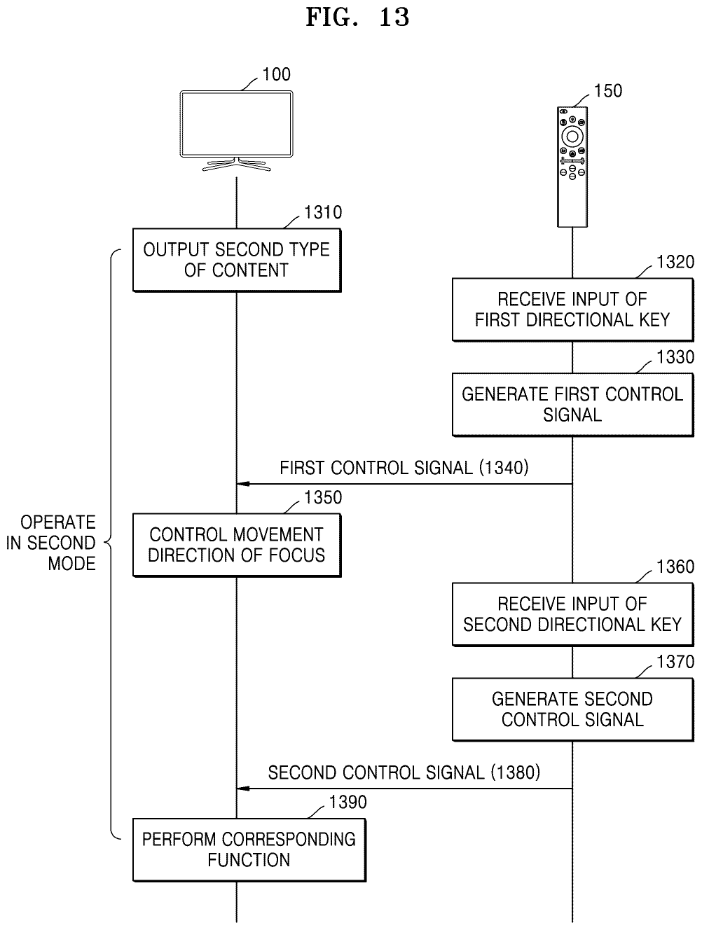

FIG. 13 is a diagram illustrating how the electronic apparatus 100 controls content to be output in a second mode based on a control signal from the control apparatus 150, according to an embodiment.

Referring to FIG. 13, the electronic apparatus 100 may communicate with the control apparatus 150.

In an embodiment, the electronic apparatus 100 may output a second type of content (operation 1310). In an embodiment, the second type of content may include viewing content.

In an embodiment, when a control signal is received while the second type of content is output, the electronic apparatus 100 may control the content to be output in the second mode.

In an embodiment, the electronic apparatus 100 may output, along with the second type of content, a guide UI indicating an operation to be performed based on selection of a directional key. A user may operate the directional key by using the guide UI.

In an embodiment, the control apparatus 150 may receive an input of the first directional key from the user (operation 1320). In an embodiment, the control apparatus 150 may generate a first control signal in response to the first directional key 151 being selected (operation 1330). The first control signal may include a control signal including a key code instruction corresponding to each direction of the first directional key 151.

In an embodiment, the control apparatus 150 may transmit the first control signal to the electronic apparatus 100 (operation 1340).

In an embodiment, the electronic apparatus 100 may control a movement direction of a focus based on the first control signal. For example, the electronic apparatus 100 may move, based on the first control signal, a focus or a cursor for selecting an object included in the viewing content in one of up, down, left, and right directions.

In an embodiment, the control apparatus 150 may receive an input of the second directional key from the user (operation 1360). The control apparatus 150 may generate a second control signal in response to the second directional key 155 being selected (operation 1370). The second control signal may include a control signal including a key code instruction corresponding to each direction of the second directional key 155.

In an embodiment, the control apparatus 150 may transmit the second control signal to the electronic apparatus 100 (operation 1380).

In an embodiment, the electronic apparatus 100 may perform a corresponding function based on the second control signal (operation 1390). An operation executed according to the input of the second directional key 155 may vary according to the screen.

In an embodiment, the electronic apparatus 100 may perform, based on the second control signal, an operation displayed on a guide UI indicating an operation to be performed based on the selection of the second directional key 155.

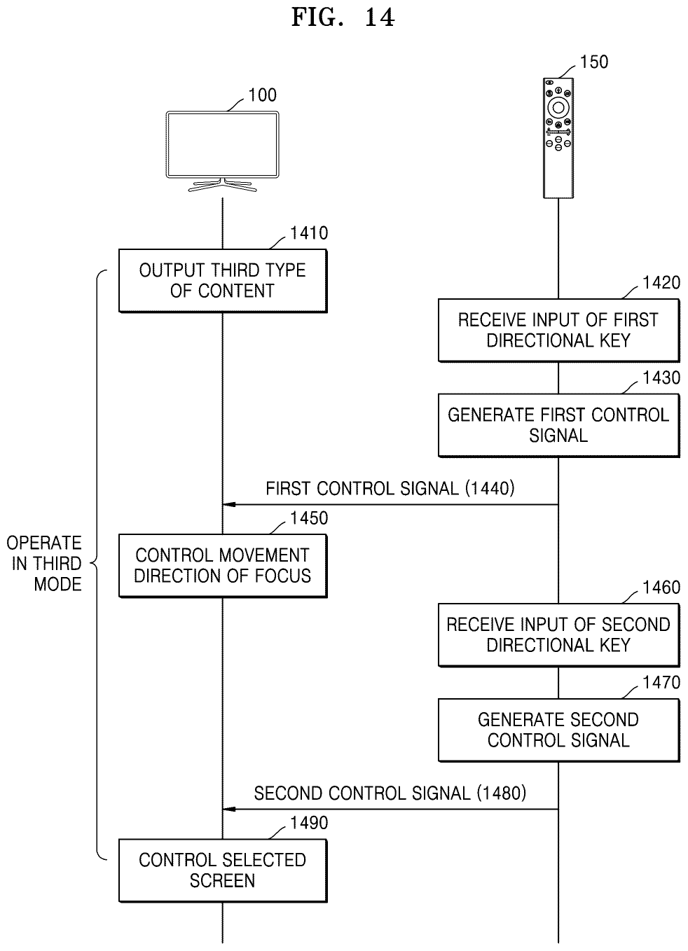

FIG. 14 is a diagram illustrating how the electronic apparatus 100 controls content to be output in a third mode based on a control signal from the control apparatus 150, according to an embodiment.

Referring to FIG. 14, the electronic apparatus 100 may output a third type of content (operation 1410). In an embodiment, the third type of content may include video call content. In an embodiment, when a control signal is received while the third type of content is output, the electronic apparatus 100 may control the content to be output in the third mode.

In an embodiment, the electronic apparatus 100 may output, along with the third type of content, a guide UI that guides an operation corresponding to an input of a directional key.

In an embodiment, the control apparatus 150 may receive an input of the first directional key from a user (operation 1420). The control apparatus 150 may generate a first control signal in response to the first directional key 151 being selected (operation 1430). The first control signal may include a control signal including a key code instruction corresponding to one of four directions included the first directional key 151.

In an embodiment, the control apparatus 150 may transmit the first control signal to the electronic apparatus 100 (operation 1440).

In an embodiment, the electronic apparatus 100 may control a movement direction of a focus based on the first control signal (operation 1450).

In an embodiment, the control apparatus 150 may receive an input of the second directional key from the user (operation 1460) and generate a second control signal corresponding to the second directional key 155 accordingly (operation 1470). The second control signal may include a control signal including a key code instruction corresponding to each direction of the second directional key 155.

In an embodiment, the control apparatus 150 may transmit the second control signal to the electronic apparatus 100 (operation 1480).

In an embodiment, the electronic apparatus 100 may control a selected screen based on receiving the second control signal from the control apparatus 150 (operation 1490). For example, the electronic apparatus 100 may adjust the position or size of the selected screen. Also, the electronic apparatus 100 may adjust the selected screen by adjusting the angle of view or zooming in or zooming out by controlling a camera provided in the electronic apparatus 100 based on the second control signal.

The operating method of the electronic apparatus and the apparatus therefor according to some embodiments may be embodied as a storage medium including instructions executable by a computer such as a program module executed by the computer. The computer-readable recording medium may be any available medium which is accessible by a computer, and may include a volatile or nonvolatile medium and a detachable or non-detachable medium. Also, the computer-readable recording medium may include both a computer storage medium and a communication medium. Examples of the computer storage medium include all volatile and nonvolatile media and separable and non-separable media, which have been implemented by an arbitrary method or technology, for storing information such as computer-readable instructions, data structures, program modules, and other data. The communication medium may include computer-readable instructions, data structures, program modules, other types of data in a modulated data signal, such as carrier waves, or other transmission mechanisms, and includes any information delivery media.

In addition, the electronic apparatus and the operating method thereof, according to the aforementioned embodiment of the present disclosure, may be implemented as a computer program product including a computer-readable recording medium/storage medium having recorded thereon a program for implementing the operating method of the electronic apparatus, the operating method including receiving a control signal from a control apparatus, when content being output is a first type of content, controlling the content to be output in a first mode based on the control signal, and when the content being output is a second type of content, controlling the content to be output in a second mode based on the control signal, wherein the control signal includes at least one of a first control signal based on selection of a first directional key provided on the control apparatus and a second control signal based on selection of a second directional key different from the first directional key.

A machine-readable storage medium may be provided in the form of a non-transitory storage medium. In this regard, the “non-transitory storage medium” means that the storage medium is a tangible apparatus and does not include a signal (e.g., an electromagnetic wave), but this term does not differentiate between where data is semi-permanently stored in the storage medium and where the data is temporarily stored in the storage medium. For example, the “non-transitory storage medium” may include a buffer in which data is temporarily stored.

According to an embodiment, the method according to various embodiments provided in the present document may be provided by being included in a computer program product. The computer program product may be traded as a product between a seller and a buyer. The computer program product may be distributed in the form of a machine-readable storage medium (e.g., a CD-ROM), or distributed (e.g., downloaded or uploaded) through an application store, or directly or online between two user devices (e.g., smart phones). In the case of online distribution, at least a portion of a computer program product (e.g., a downloadable application) may be temporarily stored in a machine-readable storage medium, such as memory of a manufacturer's server, an application store's server, or a relay server, or may be temporarily generated.

What is claimed is:

1. An electronic apparatus comprising:
a display;
a communication interface;
memory storing one or more instructions; and
one or more processors operatively connected to the display, the communication interface and the memory,
wherein the one or more instructions, when executed by the one or more processors, cause the electronic apparatus to:
receive a control signal from a control apparatus via the communication interface,
based on content to be output via the display being a first type of content, output the content, via the display, in a first mode based on the control signal, and
based on the content being a second type of content, output the content, via the display, in a second mode based on the control signal, and
wherein the control signal comprises at least one of a first control signal based on a selection of a first directional key of the control apparatus, and a second control signal based on a selection of a second directional key of the control apparatus that is different from the first directional key.

2. The electronic apparatus of claim 1, wherein the first type of content comprises metaverse content, and the second type of content comprises viewing content.

3. The electronic apparatus of claim 2, wherein the one or more instructions, when executed by the one or more processors, cause the electronic apparatus to output, via the display, a guide user interface (UI), and
wherein the guide UI comprises at least one of a first guide UI indicating a first operation to be performed based on the selection of the first directional key, and a second guide UI indicating a second operation to be performed based on the selection of the second directional key.

4. The electronic apparatus of claim 3, wherein the one or more instructions, when executed by the one or more processors cause the electronic apparatus to output, via the display, the guide UI at a preset time interval or at a time based on an event occurring, and
wherein the event comprises at least one of a first event in which a type of content being output via the display is changed, and a second event in which a function controlled based on the control signal is changed.

5. The electronic apparatus of claim 4, wherein the one or more instructions, when executed by the one or more processors, cause the electronic apparatus to, based on the content being output via the display being the first type of content, control the content to be output via the display in the first mode by:
controlling a movement direction of an avatar in the metaverse content based on one control signal from among the first control signal and the second control signal, and
controlling a gaze direction of the avatar based on another control signal from among the first control signal and the second control signal.

6. The electronic apparatus of claim 5, wherein the one or more instructions, when executed by the one or more processors, cause the electronic apparatus to:
receive, from the control apparatus via the communication interface, a sensing signal for a movement of the control apparatus, and
control a gesture of the avatar based on the sensing signal.

7. The electronic apparatus of claim 2, wherein, the one or more instructions, when executed by the one or more processors, cause the electronic apparatus to, based on the content being output being the second type of content, control the content to be output, via the display, in the second mode by:
controlling, based on the first control signal, a movement direction of a focus for selecting an object included in the viewing content, and
allowing, based on the second control signal, a function corresponding to the second control signal to be performed, the function being performable on a screen for the viewing content currently being output.

8. The electronic apparatus of claim 7, wherein the one or more instructions, when executed by the one or more processors, cause the electronic apparatus to:
output, via the display, a second guide UI indicating an operation to be performed based on the selection of the second directional key; and
based on the second control signal being received, allow the function corresponding to the second control signal to be performed without receiving an additional control signal, and
wherein the function corresponding to the second control signal corresponds to the operation, and the operation is guided by the second guide UI.

9. The electronic apparatus of claim 1, wherein the one or more instructions, when executed by the one or more processors, cause the electronic apparatus to, based on the content to be output, via the display, being a third type of content comprising video call content, control the content to be output, via the display, in a third mode based on the control signal by:
controlling, based on the first control signal, a movement direction of a focus for selecting one screen from among a plurality of screens included in the video call content, and
adjusting, based on the second control signal, at least one of a size, a position, an angle of view, and a zoom function, of the selected screen.

10. A control apparatus comprising:
an input interface;
a communication interface;
memory storing one or more instructions; and
one or more processors operatively connected to the input interface, the communication interface, and the memory,
wherein the one or more instructions, when executed by the one or more processors, cause the control apparatus to transmit, via the communication interface, a control signal to an electronic apparatus,
wherein the input interface comprises a first directional key and a second directional key that is different from the first directional key, and
wherein the first directional key is provided on a front surface of the control apparatus, and the second directional key is provided on the front surface, a back surface, a rear surface, or a side surface of the control apparatus.

11. The control apparatus of claim 10, wherein the first directional key and the second directional key are positioned within a range on the control apparatus such that the first directional key and the second directional key are simultaneously operable by a user with one hand.

12. An operating method of an electronic apparatus, the operating method comprising:
receiving a control signal from a control apparatus;
based on content to be output, via a display, being a first type of content, outputting the content, via the display, in a first mode based on the control signal; and
based on the content being output, via the display, being a second type of content, outputting the content, via the display, in a second mode based on the control signal,
wherein the control signal comprises at least one of a first control signal based on a selection of a first directional key of the control apparatus and a second control signal based on a selection of a second directional key of the control apparatus that is different from the first directional key.

13. The operating method of claim 12, wherein the first type of content comprises metaverse content, and the second type of content comprises viewing content.

14. The operating method of claim 13, further comprising outputting, via the display, a guide user interface (UI),
wherein the guide UI comprises at least one of a first guide UI indicating a first operation to be performed based on the selection of the first directional key, and a second guide UI indicating a second operation to be performed based on the selection of the second directional key.

15. The operating method of claim 14, wherein the outputting the guide UI comprises outputting, via the display, the guide UI at a preset interval or at a time based on an event occurring, and
wherein the event comprises at least one of a first event in which a type of content being output, via the display, is changed, and a second event in which a function controlled based on the control signal is changed.
